(19) United States
(12) Patent Application Publication
(10) Pub. No.: US 2005/0166151 A1
(43) Pub. Date: Jul. 28, 2005

(54) Network information processing system, information creation apparatus, and information processing method

(76) Inventors: Masaaki Isozaki, Kanagawa (JP); Toru Miyake, Kanagawa (JP)

Correspondence Address: William S Frommer;Frommer Lawrence & Haug, 745 Fifth Avenue, New York, NY, 10151, US

(21) Appl. No.: 10/497,401

(22) PCT Filed: Dec. 3, 2002
(86) PCT No.: PCT/JP02/12642

(30) Foreign Application Priority Data
Dec. 3, 2001 (JP) 2001-368865

(51) Int. Cl. G06F 3/00

(52) U.S. Cl. 715/733

(57) ABSTRACT

As shown in FIG. 13, a network-information-processing system comprises: at least one notebook personal computer (PCi); a plurality of presentation apparatuses (10A-10C) for displaying images based on the information transferred from the notebook personal computer(s) (PCi); a creator (5) for storing contents DIN displayed on the presentation apparatus (10A), for example, together with their time information and creating electronic information DOUT; and a communication cable (40) for connecting the notebook personal computer(s) (PCi), the presentation apparatus (10A), and the creator (5) to each other. The presentation apparatus (10A) and the like detects, based on input operation function of the notebook personal computer(s) (PCi), which image of those displayed on the presentation apparatuses (10A, 10B, and 10C) at present is targeted and controls the creator (5) so that identification information concerning the target image can be linked with their time information to store them.

### TECHNICAL FIELD

The present invention relates to a network-information-processing system, an information-creating apparatus, and an information-processing method that are well applicable to a network electronic conference system, a network education system, a network game system, etc.

More particularly, it relates to the ones wherein an information-processing apparatus, information-controlling-and-displaying means, an information-creating apparatus and the like are connected to each other through communication means, thereby determining which image of those displayed by information-controlling-and-displaying means at present is targeted based on an input operation function of this information-processing apparatus, linking identification information concerning the target image with its time information to store them in the information-creating apparatus, so that electronic information that is the most notable in the contents thereof can be secured in data stream and the target image can be displayed, for example, so as to be highlighted as compared with another image when reproducing the electronic information.

### BACKGROUND ART

Recently, a so-called electronic conference system has been often employed by which a presenter (a person who makes a presentation of materials) brings into a conference room the presentation materials created using a personal computer and presents the materials to a plurality of other conference attendees using an electronic apparatus.

In this electronic conference system, a display device and a notebook personal computer of the presenter of materials are connected to each other. As this display device, a data projector is used so that presentation materials created by a personal computer may be displayed. To the data projector (hereinafter referred to as “projector” simply), a notebook personal computer of one presenter is connected through an RGB-color signal cable, so that a screen being displayed on this notebook personal computer is projected to a white wall etc. Any presentation materials projected on the white wall etc. are pointed by a mouse cursor operated by the presenter. That is, only the materials owned by a presenter are displayed on the white wall etc.

Recently, such a data projector as to accommodate networks is available. This projector has built-in personal computer function. By using such the projector, the presenter transfers a presentation file from his or her notebook personal computer (hereinafter referred to as “information-processing apparatus” also) via a network to a projector so that the projector may display and project the contents thereof utilizing the personal computer function of this projector.

However, in the conventional electronic conference system, if such a system is organized that multiple presentation materials are concurrently displayed on display devices such as multiple projectors to proceed the presentation, thereby automatically creating the electronic information such as records of conference from the presentation materials, such the system has the following problems.

\mathring{1} For information-creating system for creating the electronic information such as the records of conference, it requires to recognize that the presenter of materials presents the materials with him or her seeing any screens. This is because the presenter of materials can notify a viewer which image is the most notable when reproducing the images such as the records of conference.

\mathring{2} In such a case, according to such the information-creating system, it is impossible to secure in data stream the electronic information of the image that is the most notable in the contents of presentations, for example, so that a possibility occurs that any image the presenter has not targeted is edited and entered into the reproduced images.

### DISCLOSURE OF THE INVENTION

A network-information-processing system related to the present invention comprises at least one information-processing apparatus having an input operation function to process arbitrary information, at least one information-controlling-and-displaying means for displaying an image based on information transferred from the information-processing apparatus, information-creating apparatus for storing contents displayed on the information-controlling-and-displaying means together with their time information to create electronic information, communication means for connecting at least the information-processing apparatus, the information-controlling-and-displaying means and the information-creating apparatus, determining means for determining which image of those displayed on the information-controlling-and-displaying means at present is targeted, and identification-information-adding means for adding identification information indicating the target image that is determined by the determining means to the time information.

According to this network-information-processing system of this invention, at least one information-processing apparatus having an input operation function to process arbitrary information, a plurality of information-controlling-and-displaying means for displaying an image based on information transferred from the information-processing apparatus, and the information-creating apparatus for storing contents displayed on the information-controlling-and-displaying means together with their time information to create electronic information are connected each other through the communication means. Assuming this connection, the determining means determines which image of those displayed on the information-controlling-and-displaying means at a present time is targeted. For example, the information-controlling-and-displaying means is provided with this determining means. The identification-information-adding means adds identification information indicating the target image that is determined by the determining means to the time information. For example, the information-creating apparatus is provided with this identification-information-adding means. This is, the information-controlling-and-displaying means determines which image of those displayed on the information-controlling-and-displaying means at present is targeted and controls the information-creating apparatus so that the identification information concerning the target image is linked with the time information and the linked ones are stored.

Illustratively, in a case where the information-controlling-and-displaying means and/or the information-processing apparatus display a still image, the information-controlling-and-displaying means adds the identification information to the contents thereof every time the information-processing apparatus performs change-over of the still images. Alternatively, it adds the identification information to the contents thereof every time a information control right is transferred from the information-controlling-and-displaying means to another.

Therefore, when reproducing the electronic information created by the information-creating apparatus, it is possible to display the target image so that it can be displayed with its contour being highlighted as compared with another image based on the identification information, thus allowing a viewer to be notified of the information on which image is the most notable of the reproduced images when the information-controlling-and-displaying means displays the images.

An information-creating apparatus related to the present invention for storing desired contents together with their time information to create electronic information comprises storage device for storing the contents thereof together with their time information, and controlling apparatus for selecting the contents concerning the target image based on identification information automatically or manually added beforehand relative to the contents stored in the storage device to send the selected contents.

According to this information-creating apparatus, when desired contents are stored together with their time information to create the electronic information, the storage device stores the contents thereof together with their time information. Assuming this, the controlling apparatus reads the contents out of the storage device to select the contents concerning the target image based on the identification information automatically or manually added beforehand relative to the contents to create the electronic information.

Illustratively, the controlling apparatus automatically selects and edits the target image out of the desired contents based on the identification information, and secures in data stream the contents thus edited to create the electronic information. The electronic information thus secured in the data stream is sent out to the information-controlling-and-displaying system or the information-processing system.

This enables the electronic information on image that is the most notable of the edited contents to be collected therefrom, thereby securing it in data stream. This also enables the target image to be displayed when reproducing the electronic information so that the image can be displayed with its contour being highlighted as compared with another image. Thus, the invention is also sufficiently applied to the network-information-processing system of which the electronic information thus secured in the data stream may be preferably sent out in real time.

In an information-processing method related to the present invention, at least one information-processing system having an input operation function to process arbitrary information, at least one information-controlling-and-displaying system for displaying an image based on information transferred from the information-processing system, and the information-creating system for storing contents displayed on the information-controlling-and-displaying system together with their time information to create electronic information are connected to each other through the communication means. In storing the contents in the information-creating system, it is determined which image of those displayed on the information-controlling-and-displaying system at present is targeted and identification information indicating the determined target image is added to the time information.

According to the information-processing method of this invention, when reproducing the electronic information created by the information-creating system, it is possible to display the target image based on the identification information so that it can be displayed with its contour being highlighted as compared with another image. This allows a viewer to be notified of the information on which screen is the most notable among the reproduced screens when the screens are displayed in the information-controlling-and-displaying system.

### BRIEF DESCRIPTION OF THE DRAWINGS

FIG. 1 is a block diagram for showing a configuration of a network-information-processing system 100 according to a first embodiment related to the present invention;

FIG. 2 is a flowchart for showing a processing example in the network-information-processing system 100;

FIG. 3 is a diagram for showing a configuration of a network electronic conference system 101 according to a second embodiment related to the present invention;

FIG. 4 is a block diagram for showing an internal configuration of a communicator 3;

FIG. 5 is a block diagram for showing an internal configuration of a creator 5;

FIG. 6 is an image view for showing a display example of a GUI screen 50 at a client PC for a recorder;

FIG. 7 is an image view for showing a display example of menu screen in the GUI screen;

FIG. 8 is an image view for showing a display example of a contents-manager screen 50e;

FIG. 9 is an image view for showing a change example of images in a projector 2;

FIG. 10 is an image view for showing a editing example in a case where five images are secured in data stream in the creator 5;

FIG. 11 is a flowchart for showing a system-processing example at the network electronic conference system 101;

FIG. 12 is an image view for showing a display example of a saving confirmation screen P1 on a notebook personal computer PCi;

FIG. 13 is a diagram for showing a configuration of a network electronic conference system 102 according to a third embodiment related to the present invention;

FIGS. 14A, 14B, and 14C are image views each for showing a change example of images in projectors 2A through 2C;

FIG. 15 is a diagram for showing a transferred example of mouse-operating right among three projectors 2A through 2C and an example of relationship between target image flag FG and them;

FIG. 16 is an image view for showing a display example of a contents-reproduce screen 50f of a notebook personal computer PCi for a client;

FIG. 17 is an image view for showing a display example of a contents-edit screen 50g of a notebook personal computer PCi for a client;

FIG. 18 is a flowchart for showing a processing example at a main communicator 3A relevant the network electronic conference system 102;

FIG. 19 is a flowchart for showing a set-up example of the target flag FG;

FIG. 20 is a flowchart for showing a release example of the target flag FG; and

FIG. 21 is a diagram for showing a configuration of a network electronic conference system 103 according to a fourth embodiment related to the present invention.

### BEST MODE FOR CARRYING OUT THE INVENTION

The present invention has solved the conventional problems and, it is an object of the present invention to provide a network-information-processing system, an information-creating apparatus, and an information-processing method that enable electronic information on which image is the most notable among the contents of presentation, a conference, and the like to be secured in data stream and in reproducing the electronic information, the target image to be highlighted, for example, as compared with another image.

The following will describe an embodiment of each of the network-information-processing system, the information-creating apparatus, and the information-processing method related to the present invention with reference to drawings.

### (1) First Embodiment

The present embodiment is a highest conception of a network electronic conference system, a network education system, and a network game system, in which an information-processing apparatus, information-controlling-and-displaying means, an information-creating apparatus, and the like are connected to each other through communication means in the network-information-processing system. In this system, it is determined which image of those displayed on the information-controlling-and-displaying means at present is targeted based on an input operation function of the information-processing apparatus. This system links identification information concerning the target image with its time information to store them in the information-creating apparatus. This system enables the electronic information that is the most notable among its contents to be secured in data stream. Concurrently, this system also enables the target image to be highlighted, for example, as compared with another image in reproducing the electronic information.

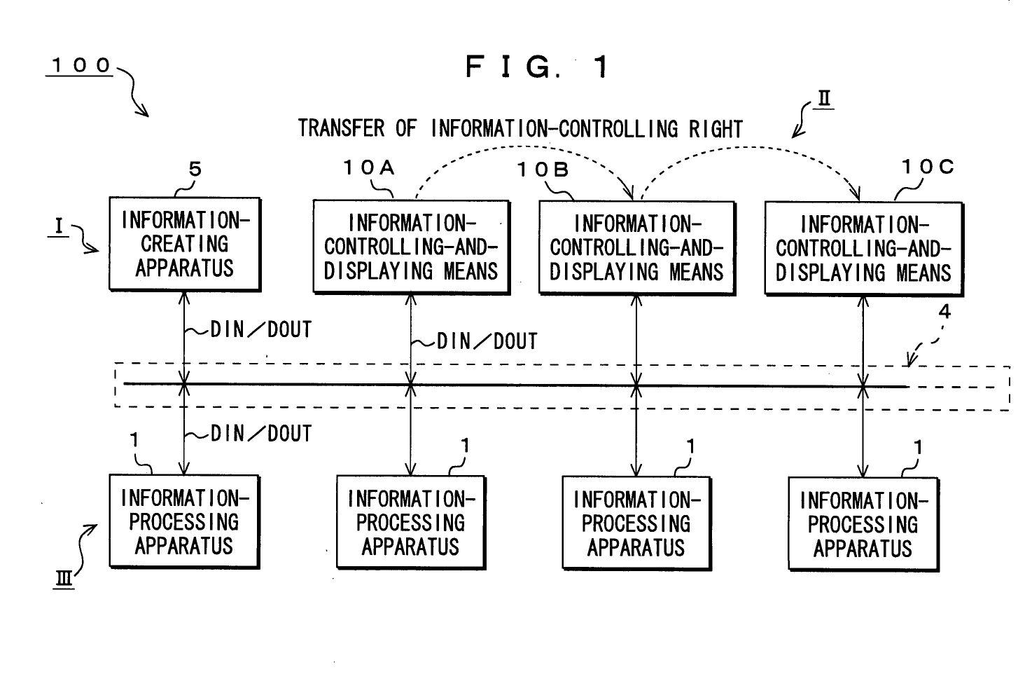

A network-information-processing system 100 shown in FIG. 1 is well applicable to a network electronic conference system, a network education system, a network game system, etc. In this system 100, information-creating apparatus 5 and at least one information-controlling-and-displaying means 10A, 10B, 10C, etc. are arranged in a specific region or a specific place such as a conference room, and at least one information-processing apparatus 1 is prepared in this specific region or place. This information-creating apparatus 5, the information-controlling-and-displaying means 10A, etc. and respective information-processing apparatus 1 are connected to each other through communication means 4, so that the information-controlling-and-displaying means 10A, etc. can be remote-controlled on the basis of operational instruction from any information-processing apparatus 1 and the information-creating apparatus 5 can store and edit its contents DIN and prepare electronic information DOUT.

The information-processing apparatus 1 has a graphic user interface (hereinafter referred to as GUI function), which is one example of the input operation function, to process arbitrary information utilizing this GUI function and a mouse operation function. As the information-processing apparatus 1, a notebook-typed personal computer (hereinafter referred to as “notebook personal computer”), which is easy to carry about, is used. Of course, not only a notebook personal computer but also a desktop type personal computer may be used. If attending in a network electronic conference system or the like, special application therefor is installed in the notebook personal computer or the like.

The communication means 4 is connected to the information-controlling-and-displaying means 10A, 10B, 10C, etc., thereby enabling an image to be displayed based on information transferred from the information-processing apparatus 1. As each of the information-controlling-and-displaying means 10A, 10B, 10C, etc., a projector and a communicator having computer functions are used. Each of the information-controlling-and-displaying means 10A, 10B, 10C, etc. is provided with determining means and identification information adding means. The determining means determines which image of those displayed on the information-controlling-and-displaying means 10A, 10B, 10C at present is targeted. The identification information adding means adds identification information indicating the target image thus determined by the determining means to its time information. Additionally, the information-controlling-and-displaying means 10A assists the electronic information processing including control in the information-creating apparatus 5 based on remote-control instruction from the information-processing apparatus 1.

For example, the information-controlling-and-displaying means 10A determines which image of those displayed on the information-controlling-and-displaying means 10A, 10B, 10C at present is targeted based on the remote-control instruction from the information-processing apparatus 1, and the information-creating apparatus 5 is controlled so as to link the identification information concerning the target image with its time information to store them. Note that relative to the image targeted herein, the information-controlling-and-displaying means 10A is included therein. Further, the identification information is refers to as information for identifying whether or not image displayed on the information-controlling-and-displaying means 10A, etc. is the target image. The identification information indicates which image a presenter of materials or its assistant explains.

When the information-controlling-and-displaying means 10A, 10B, 10C, etc. and/or the information-processing apparatus 1 display(s) a still image in the system 100, the information-controlling-and-displaying means 10A, etc. automatically adds the identification information to its contents DIN every time the information-processing apparatus 1 changes still image display. This is because changed image has a higher ratio to be remarked when changing the still image display.

When one information-processing apparatus 1 sets a right to control information in one of the information-controlling-and-displaying means 10A, 10B, 10C as an information-controlling right, this information-processing apparatus 1 automatically adds the identification information to the contents DIN of displayed subject every time the information-controlling right is transferred from the information-controlling-and-displaying means 10A to other information-controlling-and-displaying means 10B, etc. This is because the image in the transferred information-controlling-and-displaying means 10B has a higher ratio to be remarked when transferring the information-controlling right from the information-controlling-and-displaying means 10A to other information-controlling-and-displaying means 10B, etc.

In this system 100, the identification information concerning the target image is added to the contents DIN of displayed subject using the input operation function of the information-processing apparatus 1 (manual addition operation). According the manual addition operation, when explaining the corresponding screen in a course of information display processing, the presenter of materials and the assistant(s) therefor may add the identification information to the contents DIN of displayed subject on the information-controlling-and-displaying means 10A and the like. If such the identification information is previously added thereto, the target image to which the identification information has been added may be automatically selected among multiple contents (still images) when editing and creating the information.

The information-creating apparatus 5 connected with said communication means 4 stores the contents DIN displayed on the information-controlling-and-displaying means 10A, etc. together with their time information to create electronic information DOUT. For example, the information-creating apparatus 5 selects the electronic information DOUT concerning the target image based on the identification information that is automatically added relative to the contents DIN displayed on the information-controlling-and-displaying means 10A, etc. to distribute it to other information-controlling-and-displaying means 10B or other information-processing apparatus 1. Alternatively, the information-creating apparatus 5 selects the electronic information DOUT concerning the target image based on the identification information that is manually added relative to the contents DIN of this displayed subject to distribute it to other information-controlling-and-displaying means 10B or other information-processing apparatus 1.

This allows a network electronic conference system and the like that automatically selects the contents DIN having been set its identification information among the multiple presentation screens to preferably send them out in real time to be organized. This is, the information-creating apparatus 5 automatically or manually selects the target image among the contents DIN of displayed subject based on the identification information to edit it to secure the edited contents DIN in data stream and create the electronic information DOUT. This allows the electronic information DOUT of data stream form to be distributed (broadcast) in unison to information-processing apparatus 1 and information-controlling-and displaying means 10A, etc. that are arranged at other places such as remote sites.

Although the information-processing apparatuses 1, the information-controlling-and-displaying means 10A, etc., and the information-creating apparatus 5 are connected to each other through the communication means 4, it is assumed in the system 100 that the information-controlling-and-displaying means 10A, etc. are provided with wireless communication function and each of the information-processing apparatuses 1 is also provided with wireless communication function, thereby composing the communication means 4; that wireless equipment is provided as an access point, thereby composing the communication means 4; and that normal communication cables are used, thereby composing the communication means 4. Of course, a combination of these items allows a network to be built.

As the one having the wireless communication function, a wireless LAN card is used. If the wireless LAN card is used, the information-controlling-and-displaying means 10A, etc. and each of the information-processing apparatuses 1 can be connected to each other through a Peer-to-Peer mood within a specific region or place. In this case, an access point is unnecessary.

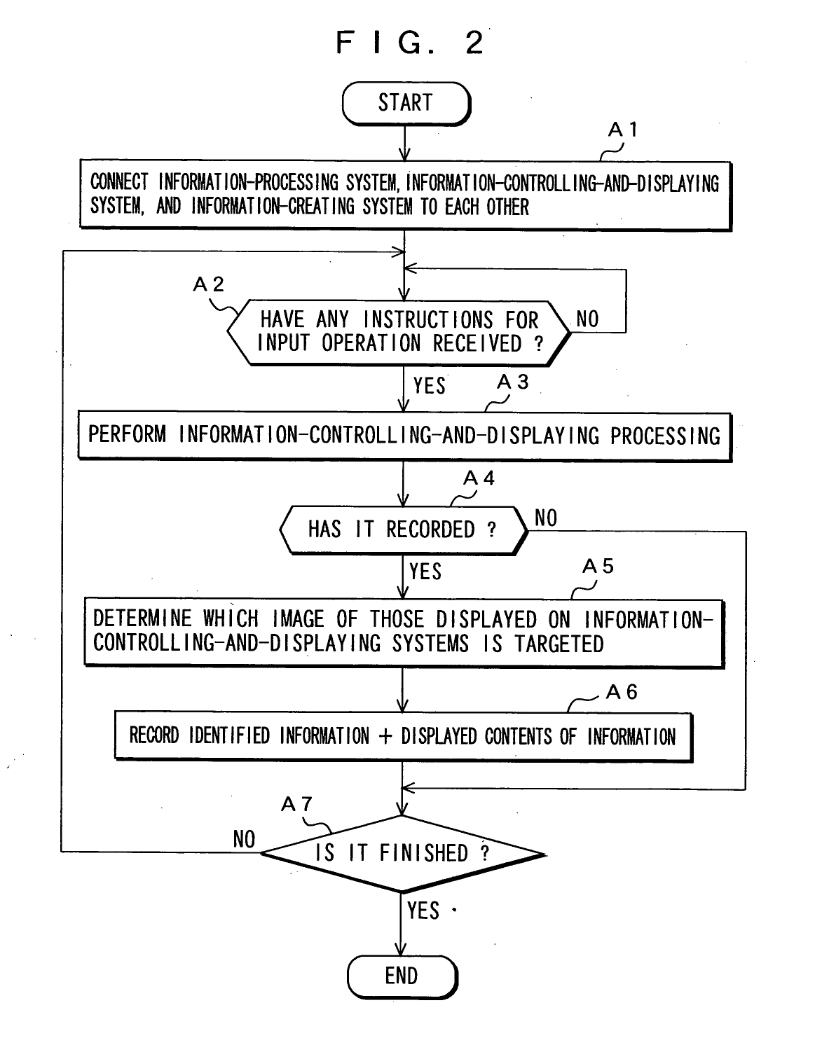

The following will describe a processing example in the network-information-processing system 100 concerning an information-processing method according to the present invention. FIG. 2 is a flowchart for showing a processing example in the network-information-processing system 100.

This first embodiment assumes a case where the information-creating apparatus 5 (an information-creating system I) and at least one information-controlling-and-displaying means 10A, 10B, 10C, etc. (an information-controlling-and-displaying system II) are arranged within a specific region or a specific place such as a conference room, and at least one information-processing apparatus 1 (an information-processing system III) is prepared within the specific region or the specific place. In this embodiment, it is assumed that any one of the information-controlling-and-displaying means 10A, 10B, 10C and the information-processing apparatus 1 displays a still image and that the information-controlling-and-displaying means 10A, 10B, 10C and the information-processing apparatus 1 display still images.

According to these processing requirements, at Step A1 in the flowchart as shown in FIG. 2, the information-creating system I, the information-controlling-and-displaying system II, and the information-processing system III are connected to each other through the communication means 4. In this time, for example, the information-controlling-and-displaying means 10A, etc. are provided with wireless communication function and each of the information-processing apparatuses 1 is also provided with wireless communication function, thereby composing the communication means 4. The information-creating apparatus 5 and the information-controlling-and-displaying means 10A, etc. are connected using the communication cable.

Of course, wireless equipment may be provided as an access point, thereby composing the communication means 4 and normal communication cables may be used, thereby composing the communication means 4. Electronic equipment for network configuration such as the information-processing apparatuses 1, the information-creating apparatus 5, and the information-controlling-and-displaying means 10A is powered on.

Then, at any information-processing apparatuses 1, an attendee in the system runs a system program for information processing, the process goes to Step A2 where the information-controlling-and-displaying means 10A, etc. wait for an instruction for input operation from any information-processing apparatuses 1. When the information-controlling-and-displaying means 10A receives any instructions for input operation from the information-processing apparatuses 1, the process goes to Step A3 where the information-controlling-and-displaying means 10A performs the information-controlling-and-displaying processing.

In this system 100, multiple items of the information-controlling-and-displaying means 10A, 10B, and 10C display images based on material information and the like transferred from any information-processing apparatuses 1. At this time, in this information-controlling-and-displaying means 10A, identification information is automatically added to its contents DIN every time the information-processing apparatus 1, for example, changes still image display.

Alternatively, when one information-processing apparatus 1 controls information in one of the information-controlling-and-displaying means 10A, 10B, and 10C, identification information is automatically added to its contents DIN every time an information-controlling right is transferred from the information-controlling-and-displaying means 10A to other information-controlling-and-displaying means 10B. Of course, identification information concerning the target image may be automatically added to its contents DIN using an input operation function of the information-processing apparatus 1 (manual addition operation).

The process then goes to Step A4 where the information-controlling-and-displaying means 10A checks whether the contents DIN respectively displayed are stored in the information-creating apparatus 5. At this time, using the input operation function of the information-processing apparatus 1, recording instruction is transferred to the information-controlling-and-displaying means 10A. The information-controlling-and-displaying means 10A detects this recording instruction to check whether the record has been performed.

If recording the contents DIN in the information-controlling-and-displaying means 10A, the process goes to Step A5. If recording no contents DIN, the process goes to Step A7. The information-controlling-and-displaying means 10A determines which image of those displayed on the information-controlling-and-displaying means 10A, 10B, and 10C at present is targeted based on the input operation function of the information-processing apparatus 1 at Step A5. The target image is found out according to the detection of the identification information added to the contents DIN thereof by the information-controlling-and-displaying means 10A, etc. The contents DIN to which the identification information is added is the target image whereas the contents DIN to which no identification information is added is non-target image.

The process then goes to Step A6 where the information-controlling-and-displaying means 10A controls the information-creating apparatus 5 so that it links the identification information concerning the target image with its time information to store them. The information-creating apparatus 5 stores the contents DIN displayed on the information-controlling-and-displaying means 10A together with their time information to create the electronic information DOUT. The electronic information DOUT may include motion image.

At Step A7, based on finish decision by the attendee in the system, remote controls to the information-controlling-and-displaying means 10A, 10B, and 10C and the information-creating apparatus 5 by the information-processing apparatus 1 are finished. The information-controlling-and-displaying means 10A detects information on power-off and finishes the information processing. If these remote controls are not finished, the process goes back to Step A2, and the above process A2 through A6 is then repeated.

Thus, according to the network-information-processing system 100 as the first embodiment relative to the present invention, the information-processing apparatuses 1, the information-creating apparatus 5, and the information-controlling-and-displaying means 10A are connected to each other through the communication means 4, so that the information-controlling-and-displaying means 10A can determine which image of those displayed on the information-controlling-and-displaying means 10A, 10B, and 10C at present is targeted by the material presenter or the like based on the input operation function of the information-processing apparatus 1, thereby controlling the information-creating apparatus 5 so that it links the identification information concerning the target image with its time information to store them.

Therefore, based on the identification information, it is possible to display the target image so that its contour can be highlighted as compared with another when reproducing the electronic information DOUT created by the information-creating apparatus 5, thus enabling a viewer to be notified which image is the most notable in the reproduced images at displayed time in the information-controlling-and-displaying means 10A, 10B, and 10C.

Thus, utilizing the network-information-processing system 100 allows a network electronic conference system, a network education system, a network game system and the like to be organized.

### (2) Second Embodiment

In the present embodiment, a network electronic conference system 101, which is one example of network-information-processing systems, is organized so that it is determined which image of those displayed on the information-controlling-and-displaying means at present is tergeted based on the input operation function of the information-processing apparatus thereby linking the identification information concerning the target image with the time information to store them in the information-creating apparatus.

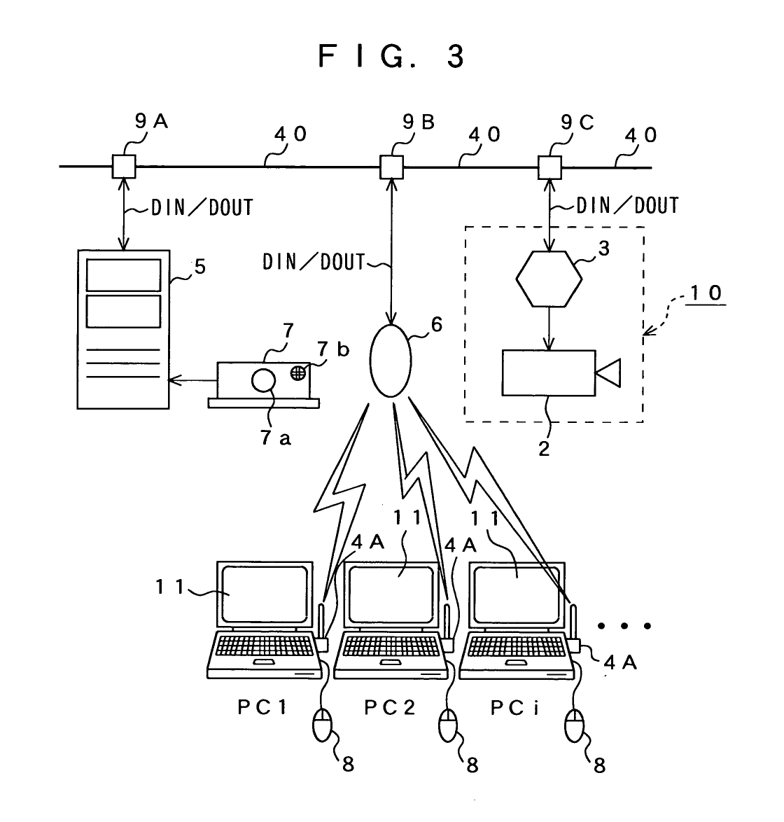

The network electronic conference system 101 as shown in FIG. 3 is a presentation system utilizing a network in which a creator 5, which is an example of the information-creating apparatus, and a presentation apparatus 10, which is an example of the information-controlling-and-displaying means, are arranged in one conference room or the like as well as plural notebook personal computers PCi (i=1 to n), which are an example of the information-processing apparatus, are prepared in the conference room. The presentation apparatus is composed of a projector 2 and a communicator 3, which will be described later.

These creator 5 and presentation apparatus 10 are connected to each other through centralized connectors (hereinafter referred to as HUBs) 9A, 9B, and 9C, communication cables 40 constituting a wired LAN, and the like, which are an example of the communication means. HUBs 9A, 9B, and 9C are connected to each of the communication cables 40.

This presentation apparatus 10 and each of the notebook personal computers PCi are connected to each other through an access point 6 and a wireless LAN, which are an example of the communication means, so that the presentation apparatus 10 can be remote-controlled based on operation instructions from any notebook personal computers PCi.

In other words, an access by connecting the notebook personal computers PCi to the presentation apparatus 10 via the network allows the network electronic conference system 101 to be organized. This network electronic conference system 101 may operate solely or be used with it being remote-connected with another same system.

In the system 101, conference attendee(s) use(s) the notebook personal computer (s) PCi that can be connected to the network. Each of the notebook personal computers PCi has GUI function so that they can perform arbitrary information processing utilizing the GUI function and a mouse operation function. Each of the notebook personal computers PCi is provided with a liquid crystal display 11 on which an operation screen such as a GUI screen is displayed. If attending in the network electronic conference system 101, a special application is installed to each of the notebook personal computers PCi.

Although the presentation apparatus 10 is prepared in this system 101, the presentation apparatus 10 is composed of a projector 2 for projecting presentation materials, a communicator 3 incorporating a personal computer function, and the like. Of course, the projector 2 may use a network-corresponding typed display device with a built-in communication function.

In this embodiment, the HUB 9C is connected to the communicator 3 that controls image display for presentation based on information of materials etc. transferred from any notebook personal computers PCi. In other words, the communicator 3 assists information processing in the network that includes input/output control to/from the projector 2 and the creator 5 based on the remote-control instruction from any notebook personal computers PCi. Further, a main communicator 3 administrates the notebook personal computer(s) PCi that is(are) used by the conference attendee(s). The main communicator 3 has such a relationship that it can obtain information-controlling right to control other sub-communicator(s).

In the projector 2, an image for presentation is displayed based on the information of materials from any notebook personal computers PCi. The projector 2 projects a color image on white wall or the like based on RGB signal. Instead of the projector 2, a flat panel display or the like may be used. As the flat panel display, plasma display or the like that is capable of being made large-scale display screen.

In this embodiment, television conference apparatus 7 (for example, SONY-made PCS-1600) that can be controlled via LAN connection is provided as an example of motion image and audio input apparatus, and obtains at least motion image and audio information within the conference room other than the information of materials transferred from the notebook personal computers PCi. The television conference apparatus 7 has a video camera 7a and a microphone 7b as the audio input apparatus. In this embodiment, the television conference apparatus 7 directly connects the creator 5, and has such a configuration that its operation mode can be controlled according to instructions from any notebook personal computers PCi of a client.

The creator 5 connects the above HUB 9A and the television conference apparatus 7 and stores the contents DIN displayed using the projector 2 and motion image and audio information obtained by the television conference apparatus 7 together with its time information to create the electronic information DOUT. It is the aim of making a record from the contents in the electronic conference and preserving it to create such the electronic information DOUT. The creator 5 also edits the contents DIN to secure it in data stream, thereby creating the electronic information DOUT. It is the aim of distributing the record of conference via network to create the electronic information DOUT due to the data stream.

Although the communicator 3 and the creator 5 are connected to each other through the communication cable 40, the HUB 9B connects the access point 6 in this system 100 so that it can perform the wireless communication processing toward a wireless LAN card 4A installed in the notebook personal computers PCi. Of course, wired communication processing may be performed using normal communication cable. A combination of these items allows a network to be built. Further, the communicator 3 may be provided with wireless LAN function, thereby performing the wireless communication processing such that it directly access the wireless LAN card 4A installed in each of the notebook personal computers PCi (a Peer-to-Peer mood).

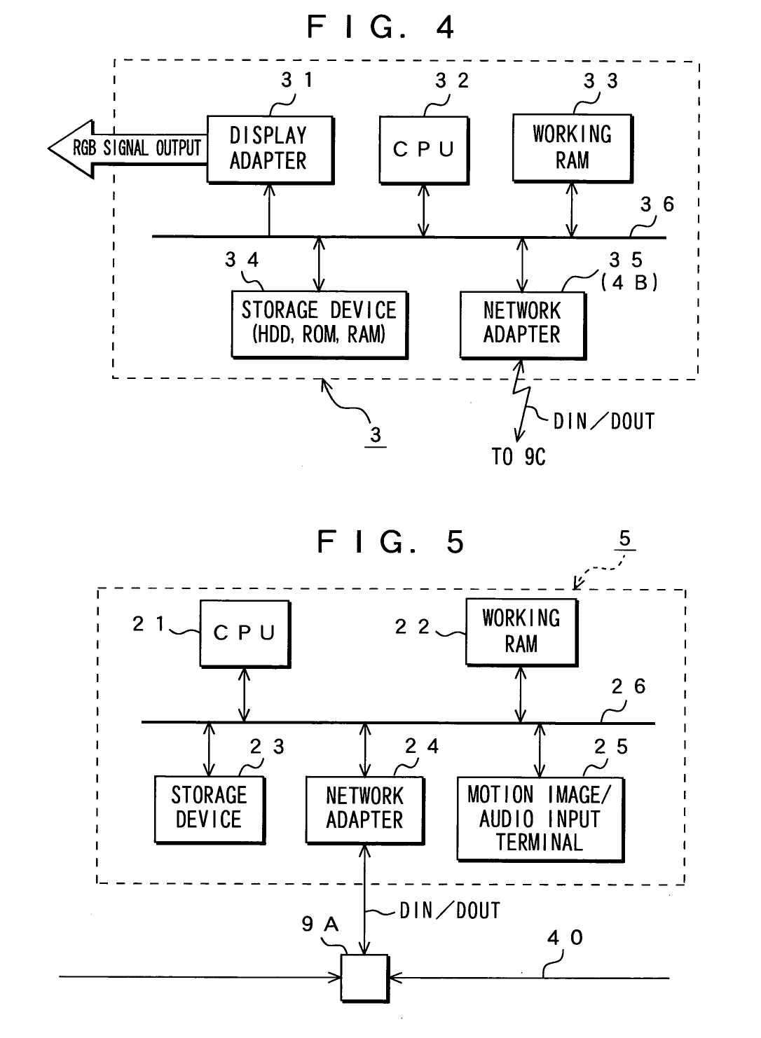

Next, the following will describe an internal configuration of the communicator 3. FIG. 4 is a block diagram for showing an internal configuration of a communicator 3.

The communicator 3 shown in FIG. 4 has a personal computer function and performs information processing by operating a mouse of any notebook personal computers PCi. The communicator 3 has a data bus 36, to which a display adapter 31, a CPU32, a working RAM 33, a data storage device 34, a network adapter 35, and the like are connected.

The display adapter 31 has a function for processing presentation materials to create an RGB signal. This RGB signal based on the presentation materials is output to the projector 2. The working RAM 33 temporarily stores a private IP address and transfer information related to the presentation materials.

The data storage device 34 is constituted of a hard disk (HDD), an ROM, and an RAM, not shown. The hard disk stores the presentation materials. In the ROM, a control program (hereinafter referred to as “system-assisting-control program”) for assisting an electronic conference system 101 is described. The system-assisting-control program is comprised of basic software for operating CPU 32 and a presentation-data-processing program.

The network adapter 35 sends and receives presentation data and a variety of kinds of commands to and from the notebook personal computers PCi. The network adapter 35 connects the HUB 9C. If the communicator 3 is provided with the wireless LAN function, the wireless LAN card 4B is installed in the network adapter 35.

The CPU 32 controls input/output operations to the display adapter 31, the working RAM 33, the data storage device 34, the network adapter 35, etc. based on the system-assisting-control program. This is because a variety of kinds of programs are processed. The CPU 32 controls presentation image display based on information on the materials transferred from the notebook personal computers PCi or the like. In other words, the CPU 32 assists information processing in a network that includes input/output control in the projector 2 and the creator 5 based on remote-control instructions from any notebook personal computers PCi. Further, the CPU 32 administrates the notebook personal computer(s) PCi that are used by the conference attendee(s).

Next, the following will describe an internal configuration of the creator 5. FIG. 5 is a block diagram for showing an internal configuration of a creator 5.

The creator 5 shown in FIG. 5 is an apparatus for storing desired contents DIN together with their time information to create the electronic information DOUT and has a data bus 26. To the data bus 26, a CPU 21, a working RAM 22, a storage device 23, a network adapter 24, and motion image/audio input terminal 25 are connected.

The working RAM 22 (for example, a hard disk) temporarily stores motion image/audio information and control programs to process the transferred and received information (information related to the motion image or still image). The storage device 23 stores the contents relative to the presentation materials together with their time information as well as motion image/audio information etc. and control program for processing them.

The CPU 22 is an example of controlling apparatus and performs processing on a variety of kinds of programs as well as selects the contents DIN concerning target image based on identification information relative to the contents DIN stored in the storage device 23 to send them out. The identification information is automatically or manually added beforehand to the contents DIN of displayed subject.

The CPU 21 automatically selects the target image from the contents DIN based on the identification information to edit it. The CPU 21 then secures the contents DIN thus edited in data stream to create the electronic information DOUT of the conference contents or the like. This allows the electronic information DOUT of data stream form to be distributed (broadcast) to multiple client PCs and the communicator 3 in unison.

To the data bus 26, the motion image/audio input terminal (I/O interface) 25 is connected, and the television conference apparatus 7 is also connected, thereby enabling motion image and audio information to be received from this television conference apparatus 7. The network adapter 24 is used for connecting the communicator 3.

Thus, the CPU 21 is adapted to store the information relative to the presentation materials displayed on the communicator 3 as described above, as well as store information transferred from the communicator 3 such as the information of the attendee attended in the electronic conference (information on IP addresses or his or her face photographs), motion image and audio information, and the like. Thus, on the end of recording, it is possible to automatically create the contents in the conference, this is, a record of the conference.

If there are notebook personal computers PCi of multiple attendees in the conference, control of the above creator 5 and television conference apparatus 7 is carried out under the control of one client notebook personal computer PCi among them. This is, notebook personal computer PCi serving as a clerk (hereinafter referred to as “client PC for recorder”) administrates it. In order to become the client PC for recorder, it is enough to open a control screen (CONTROL) used for operation screen for the creator 5.

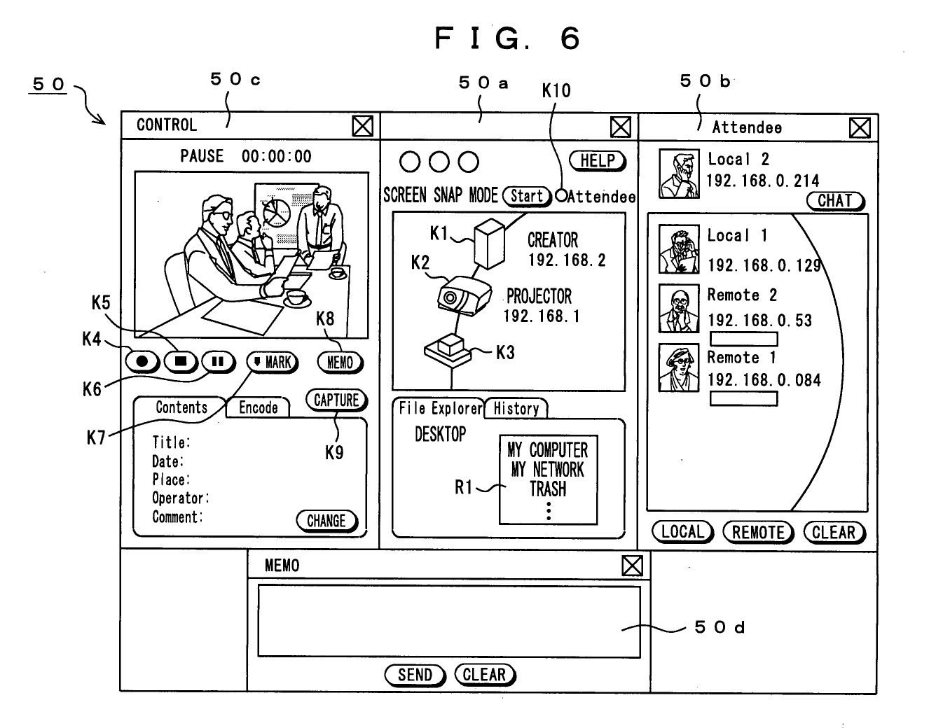

For example, a display screen as shown in FIG. 6 is composed of almost three display sub-screens employing a horizontally split-by-three display system in the client notebook personal computer PCi. On the middle thereof, a basic screen 50a is displayed; on the right side thereof, an attendee screen 50b for displaying information relative to the attendees who is participating in the conference is displayed; and on the left thereof, a control screen 50c for controlling the creator 5 is displayed. Further on the bottom of the display screen, an oblong memorandum screen is displayed.

On the upper side of the basic screen 50a, icons for electronic apparatuses constituting the network that are connected to the corresponding electronic conference system 101 are displayed. In an example as shown in FIG. 6, icon K1 for the creator 5, icon K2 for the communicator 3, and the like are displayed. Further, icon K3 for the television conference apparatus 7 is displayed.

Lower side of the basic screen 50a is used for a list column for fails, in which names of the file R1 stored in any notebook personal computers PCi of the client, which serves as the presenter, are displayed. On the attendee screen 50b, face photographs of the attendees, private IP addresses of the client PCi that the attendees have, and the like, are displayed.

On the top of the control screen 50c is image display portion on which image imaged by the video camera 7a is displayed as motion image. On the middle thereof, a line-like display area that is soft-key operation portion containing function keys is displayed, and on the bottom thereof, input portion for inputting the title is displayed. In the soft-key operation portion, a record “REC” key K4, a “stop” key K5, a pause “PAUSE” key K6, a marking “MARK” key K7 for marking important image portion in the record, a memorandum “MEMO” key K8 for opening the memorandum screen, a capture “CAPTURE” key K9 for preserving still image information (presentation materials) displayed using the projector 2, and the like, are displayed.

When the communicator 3 is logged on using the client PCi, only the basic screen 50a is displayed on the display screen of client PCi. If it performs DRUG&DROP on a file list in the file names R1 to the icon K1 of the communicator 3, that file data (presentation materials) is transferred to the communicator 3, thereby displaying it using the projector 2 to carry out the presentation. This, however, is available for only a case where a notebook personal computer PCi of a client who is qualified to carry out the presentation is operated.

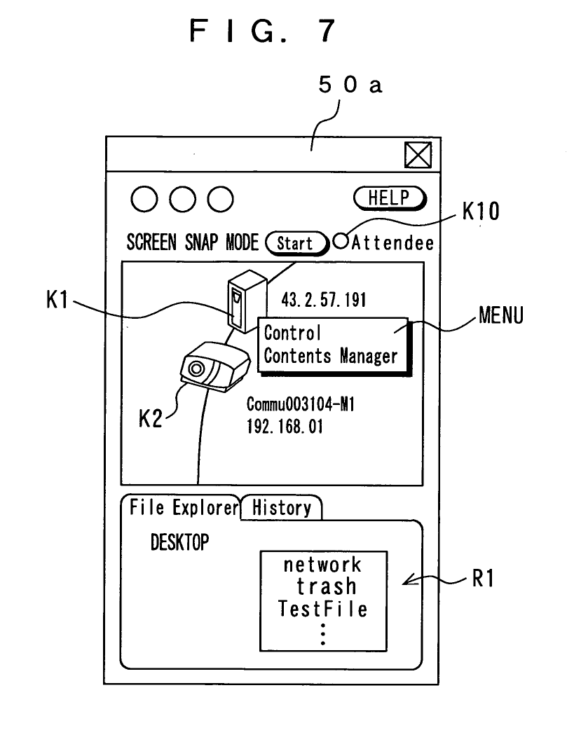

When a n attendee “Attendee” button K10 in the basic screen 50a is pushed down, the attendee screen as shown in right side of FIG. 6 is displayed. When the creator icon K1 is then right-clicked, a menu screed as shown in FIG. 7 pops up, so that if an item “Control” is selected from the menu screen, the control screen 50c shown in FIG. 6 is displayed. If the memorandum “memo” key K8 is selected from the control screen, the memorandum screen 50d is displayed on a lower portion of GUI screen 50 as shown in FIG. 6 to input a sentence or the like therein. The memorandum screen 50d has a room for a space of four to six lines.

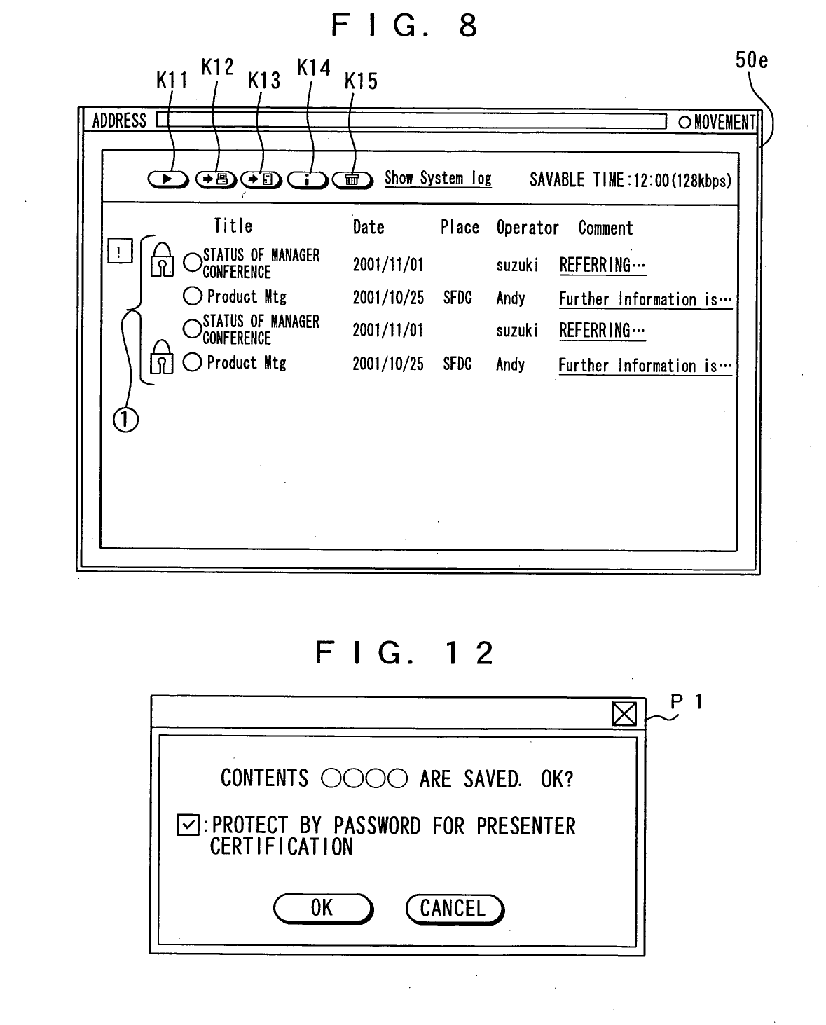

If the item “Contents Manager” is selected from the menu screen shown in FIG. 7, a contents-manager screen 50e as shown in FIG. 8 is D displayed. The contents-manager screen 50e displays a list menu stored in the creator 5. In addition to the contents list R2 stored in the creator 5, the contents-manager screen 50e as shown in FIG. 8 displays soft-keys for selecting operation modes for the selected contents list R2.

In this system 101, a review “REVIEW” key K11 for reproducing the selected contents, a client transfer “DOWNLOAD TO MY COMPUTER” key K12 for transferring the selected contents to a client PCi, a server transfer “UPLOAD TO SERVER” key K13 for transferring the selected contents to a server, a particular “SHOW CONTENTS INFORMATION” key K14 for showing detailed information on the selected contents, a delete “DELETE” key K15 for deleting the selected contents, and the like, are displayed.

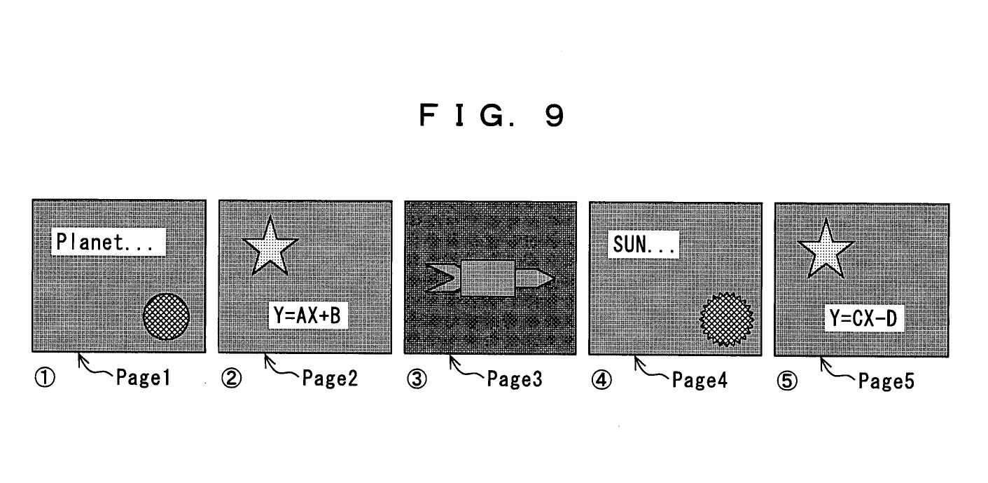

For example, five images (relative to space) as shown in FIG. 9 are illustrated as a change-over example of displayed images on the projector 2 using a notebook personal computer PCi of a presenter of materials (a client). Page 1 illustrates an image in which a round planet symbol (PLANET) is shown in right-lower portion of the displayed screen indicating space. Page 2 illustrates an image in which a star symbol is shown in left-upper portion of the displayed screen and an equation of Y=AX+B is shown under the star symbol. Page 3 illustrates an image in which a rocket symbol is shown in the middle of the displayed screen. Page 4 illustrates an image in which a round sun symbol is shown in right-lower portion of the displayed screen. Page 5 illustrates an image in which a star symbol is shown in left-upper portion of the displayed screen and an equation of Y=CX-D is shown under the star symbol.

The notebook personal computer PCi of the client instructs the timing \mathring{1} to \mathring{5} of the display changeover shown in FIG. 9 to the projector 2 via the communicator 3. According to the timing \mathring{1} to \mathring{5} of the display changeover, five images on the projector 2 are changed, so that on the point of time when all the images are changed, the creator 5 stores the five images (their contents: JPEG files) captured by the communicator 3.

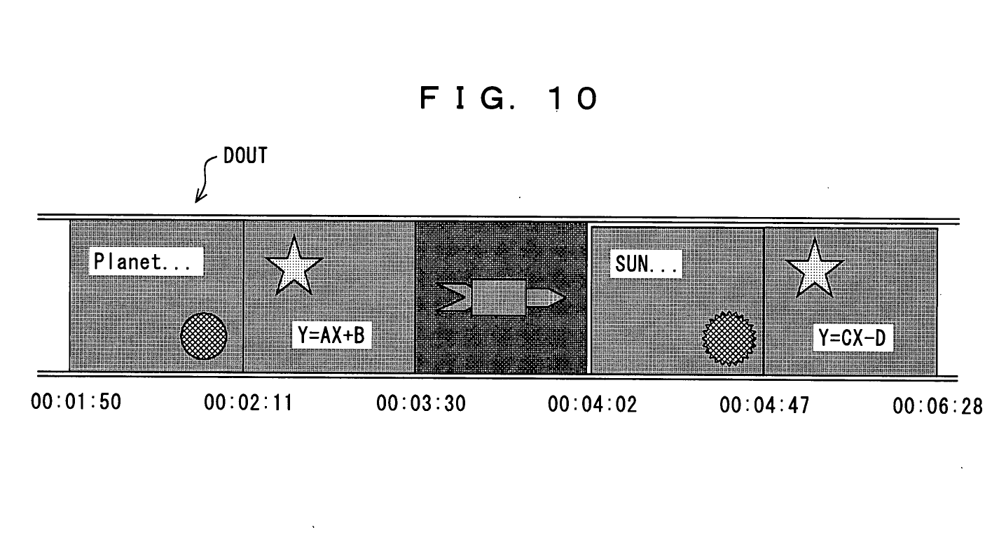

Five images as shown in FIG. 10 are obtained by securing the contents DIN stored together with their time information in one data stream and reproducing them. In this embodiment, image of the page 1 indicating space is displayed on the timing \mathring{1} of the display changeover together with the time information of 00:01:50.

Similarly, image of the page 2 is displayed on the timing \mathring{2} of the display changeover together with the time information of 00:02:11; image of the page 3 is displayed on the timing \mathring{3} of the display changeover together with the time information of 00:03:30; image of the page 4 is displayed on the timing \mathring{4} of the display changeover together with the time information of 00:04:02; and image of the page 5 is displayed on the timing \mathring{5} of the display changeover together with the time information of 00:04:47. The image of the page 5 indicates an example wherein the image is kept shown by the time information of 00:06:28.

Storing these five images (the contents DIN) together with their time information in the creator 5 allows the electronic information (contents) secured in one data stream to be created.

Next, the following will describe a processing example in the network electronic conference system 101. In this example, a presenter in the conference transmits from the notebook personal computer PCi to the communicator 3 via the network a text file(s) and/or image file(s) for the presentation. According to the transmission of the image file(s), the presentation materials may be presented on the projector 2. The presenter performs an operation for obtaining mouse-operating right on the communicator 3 so that he or she can explain with an icon showing on a display screen of the projector 2.

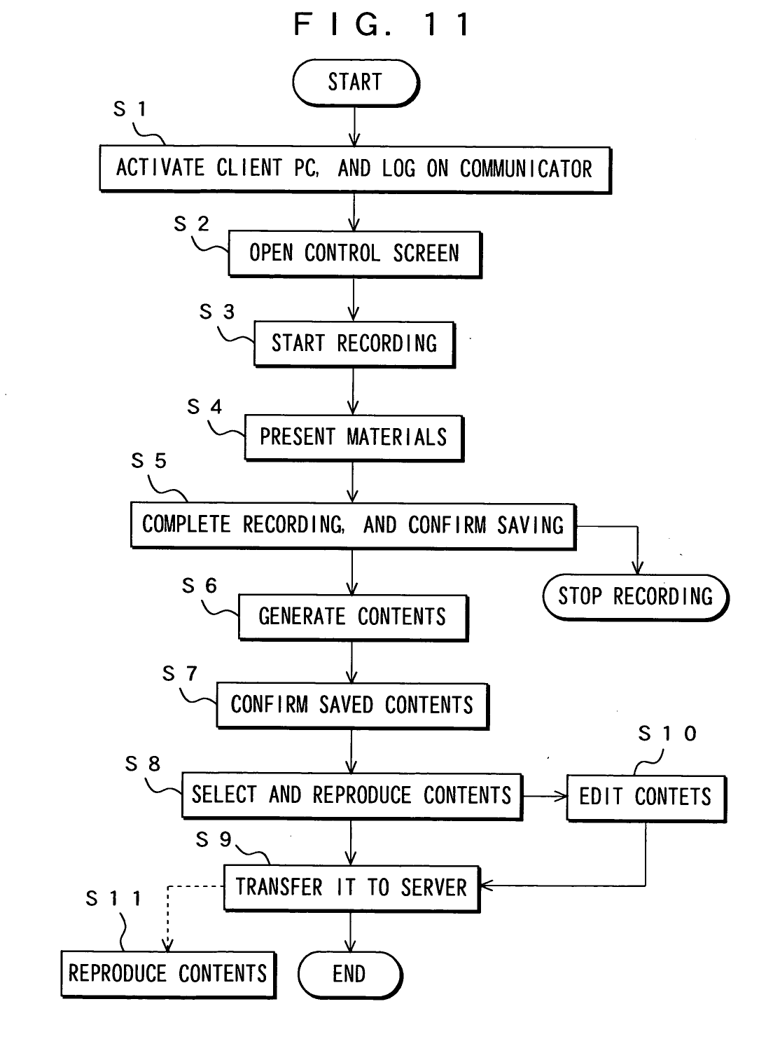

According to these processing requirements, at Step S1 in the flowchart as shown in FIG. 11, an application software for the electronic conference is activated using any notebook personal computer of the attendee in the conference to log on the communicator 3 (or main communicator).

In this case, a first attendee in the conference sets a password and then, a second attendee or later therein may attend in this conference by inputting the password. Since the password is not a predetermined value proper for this electronic conference, it is possible to solve such a disadvantageous problem that the electronic conference cannot be activated by forgetting the password or accidentally inputting it.

Then, the process goes to Step S2 where if the attendee in the conference opens the control screen 50c for allowing the attendee in the conference to operate the creator 5, only the client becomes the client PC for recorder (see FIG. 6). On GUI screen 50 of the notebook personal computer PCi, the icon K1 of the creator 5, shown in FIG. 6, is right-clicked and an item, “control” is selected from the displayed menu, the control screen 50c is displayed.

The process goes to Step S3 where if the record “REC” key K4 in the control screen is clicked, the television conference apparatus 7 is then activated to start recording images in the conference.

If the memo “MEMO” key K8 is clicked on the control screen 50c, the memo screen 50d, shown in FIG. 6, is opened to allow the text to be input. If the “SEND” key K17 as shown in FIG. 6 is clicked, the input text is taken in the creator 5.

The process goes to Step S4 where, if the presentation materials are dragged and dropped from a file list R1 of the notebook personal computer PCi to the icon K2 of the display-desired projector 2, the presentation materials selected from the file list are shown on the screen of the projector 2. At the same time of this, the presentation materials, the page-switching information, and the like are stored in working RAM 22 in the creator 5.

For example, on the communicator 3, as shown in FIG. 9, the image f the page 1 indicating space is displayed on the timing \mathring{1} of the display changeover; the image of the page 2 is displayed on the timing \mathring{2} of the display changeover; the image of the page 3 is displayed on the timing \mathring{3} of the display changeover; the image of the page 4 is displayed on the timing \mathring{4} of the display changeover; and the image of the page 5 is displayed on the timing \mathring{5} of the display changeover.

In a case where such the images are changed in display, an image displayed on the timing is captured so that each of the images can be filed according to JPEG standards and transmitted to the creator 5. In the creator 5, together with video image and audio information for the presentation (of the presenter), five images are recorded with them being linked with the time information of the creator 5, namely, the time information of 00:01:50 with respect to the timing \mathring{1} of the display changeover; the time information of 00:02:11 with respect to the timing \mathring{2} of the display changeover; the time information of 00:03:30 with respect to the timing \mathring{3} of the display changeover; the time information of 00:04:02 with respect to the timing \mathring{4} of the display changeover; and the time information of 00:04:47 with respect to the timing \mathring{5} of the display changeover.

The process goes to Step S5 where the stop, “STOP” key K5 is clicked on the control screen, if stopping the record. In the moment, the notebook personal computer PCi for the recorder side displays a saving-confirmation screen P1 as shown in FIG. 12. In every case excluding such the saving processing, the contents thereof are cancelled. In performing saving operation, the process goes to Step S6 where the contents of conference are automatically prepared.

In other words, at Step S6, the contents of the conference are prepared based on the still-picture information obtained from the communicator 3 and moving-picture-and-audio information obtained from the television conference apparatus 7. In the creator 5, five images are secured in one data-stream, as shown in FIG. 10, to generate electronic information DOUT. In order to refer the contents of the conference including those five images via a network such as the Internet, file data is converted into HTML format.

The process then goes to Step S7 where the contents-manager screen 50e is displayed when a generation of the contents of the conference is completed. On the screen 50e, it is possible to confirm the contents of the conference that are saved in the creator 5 (see FIG. 8). At Step 8, when selecting the desired contents of the conference from this contents-manager screen 50e, the contents may be reproduced. The confirmed contents are transferred to a server apparatus, not shown, and saved in it, at Step S9.

Alternatively, when the contents of the conference are reproduced and then edited at Step S8, the process goes to Step S10 where by operating the contents-manager screen 50e, the contents of the conference are transferred to a notebook personal computer PCi side in which they are edited using a known editing software. The edited server contents are transferred and saved to and in a server apparatus, not shown, at Step S9. This allows the notebook personal computer PCi for recorder to reproduce the contents of the conference saved in the server apparatus, not shown, at step 11.

### (3) Third Embodiment

In the present embodiment, it is an assumption that a network conference in which plural materials are used in three presentation apparatuses 10A, 10B, and 10C all at once proceeds. A presenter of materials and the assistant(s) therefor transmit the files of the materials to be presented to the corresponding communicators.

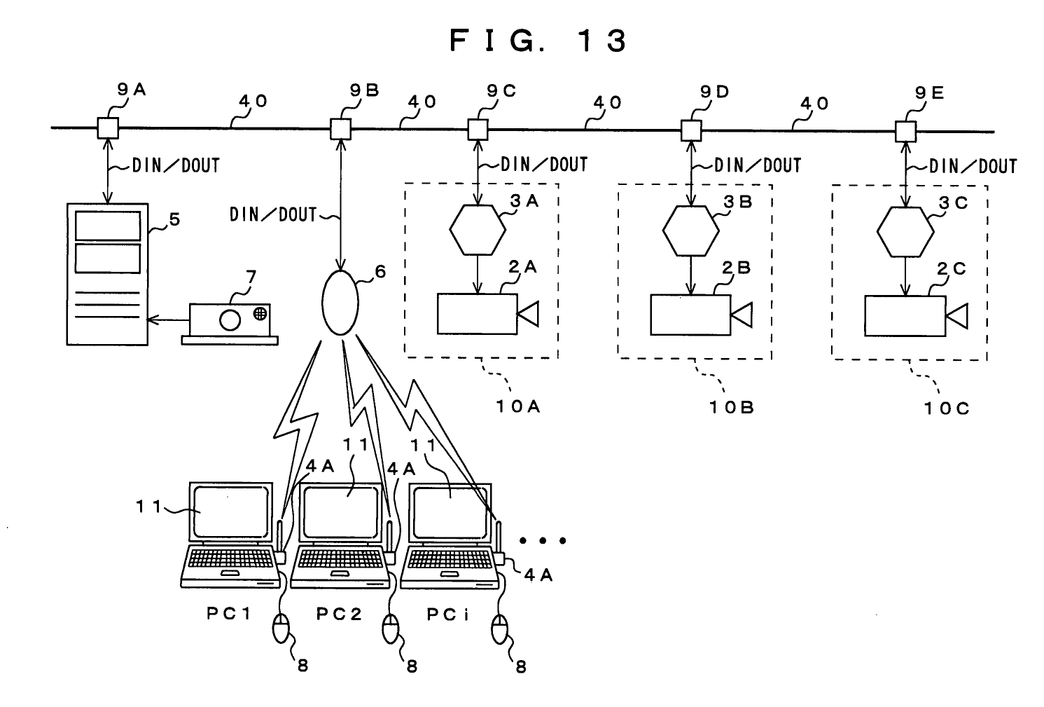

A network conference system 102 shown in FIG. 13 is organized so that presentation apparatuses 10B and 10C can be added to the system 101 shown in FIG. 3. The presentation apparatus 10A comprises a main communicator 3A and a projector 2A, the presentation apparatus 10B comprises a sub-communicator 3B and a projector 2B, and the presentation apparatus 10C comprises a sub-communicator 3C and a projector 2C.

The main communicator 3A is connected to HUB 9C, the sub-communicator 3B is connected to HUB 9D, the sub-communicator 3C is connected to HUB 9E, and the HUBS 9D and 9E are connected to a communication cable 40, which is composed of LAN together with HUBS 9A and 9B. This is because plural materials can be presented on three projectors 2A through 2C all at once.

The presenter of materials transmits text and image files for the presentation to the main communicator 3A or the sub-communicator 3B or 3C to present the presentation materials on the projector 2A, which is connected to the main communicator 3A, the projector 2B, which is connected to the sub-communicator 3B, or the projector 2C, which is connected to the sub-communicator 3C.

In the system 102, the presenter of materials and the assistant (s) therefor allows a mouse cursor to be shown on a screen to be explained to indicate an explaining portion in the screen (referred to as “Remote Cursor function”). Based on this remote cursor function, when a client PC side performs an operation for obtaining an operating right of a remote mouse (hereinafter referred to as “mouse-operating right” simply), movements in a mouse 8 of this client PC are reproduced on a presentation screen.

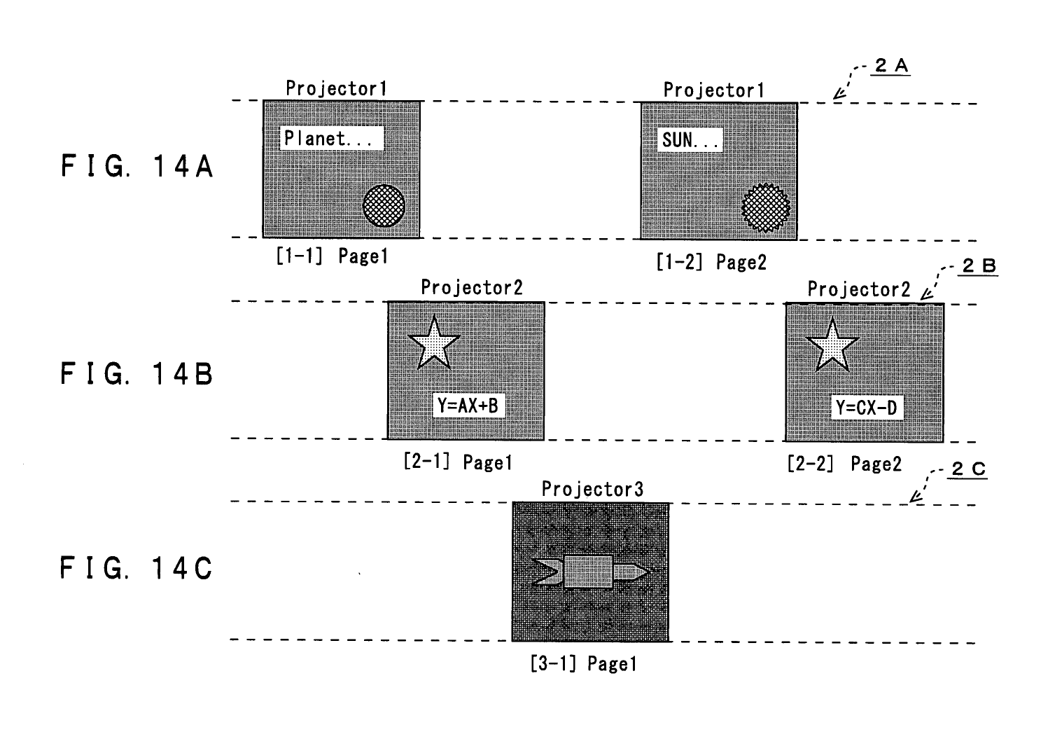

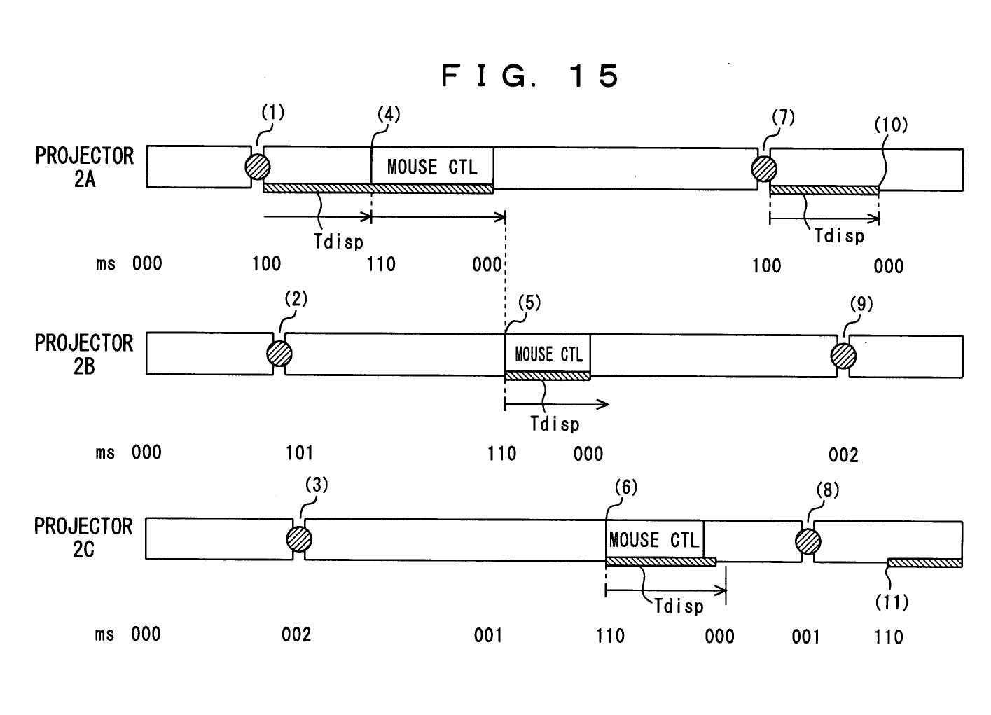

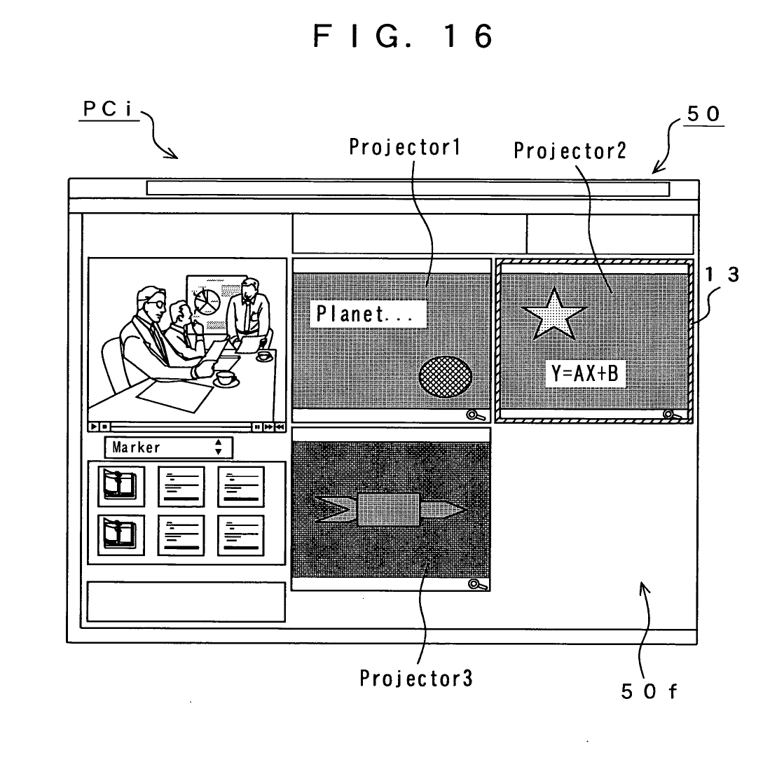

According to examples of display changeover shown in FIGS. 14A through 14C, if the presentation proceeds with plural materials being presented all at once, a presenter of materials (a client) performs display changeover operation of five images (concerning space) on the projectors 2A trough 2C using his or her notebook personal computer PCi.

In the projector 2A shown in FIG. 14A, a display image of page 1 indicating space is displayed on the timing [1-1] of the display changeover and a circular planet image (PLANET) is put on a right lower portion of the display image. A display image of page 2 of which a circular image indicating the sun (SUN) is put on a right lower portion is displayed on the timing [1-2] of the display changeover.

Similarly, in the projector 2B shown in FIG. 14B, a display image of the page 1 of which a star image is put on a left upper portion as well as an image indicating an equation of Y=AX+B is put on a portion under the star image is displayed on the timing [2-1] of the display changeover. The display image of the page 2 of which a star image is put on a left upper portion as well as an image indicating an equation of Y=CX−D is put on a portion under the star image is displayed on the timing [2-2] of the display changeover.

Further, in the projector 2C shown in FIG. 14C, a display image of the page 1 of which an image indicating a rocket is put on a middle portion is displayed on the timing [3-1] of the display changeover. Thus, the images are changed on the three projectors 2A through 2C.

When the creator 5 records the contents of the network conference under the use condition of such the projectors 2A through 2C, only informing the creator 5 of the display changeover of the images on the communicator 3A and recording the contents DIN concerning the displayed image at this time together with the time information thereof, as the second embodiment, prevents a viewer from understanding that the presenter of materials explains any image at present with him or her notifying it.

Thus, according the third embodiment, it is determined in the main communicator 3A and the like which image of those of the projectors 2A, 2B, and 2C the presenter of materials notifies at present based on an input operation function of a notebook personal computer of a client (hereinafter referred to as “client PC”) and the creator 5 is controlled so that a target image flag FG (M. V. P) is linked with its time information and recorded. Note that the target image flag FG is an example of identification information and refers to information for identifying whether or not a presently displayed image concerning the displayed image of the projector 2A, 2B, or 2C is the target image. In other words, the target image flag FG indicates which image the presenter of materials and assistant(s) therefor explain.

In the system 102, when still images are displayed using the projectors 2A through 2C and/or the client PC, the main communicator 3A and the like automatically adds the target flag FG to the contents DIN thereof every time the client PC performs display changeover operation on the still images. This is because the changed image has more notified proportion in the display changeover of the still images.

When the client PC sets as a mouse-operating right a right of controlling information in any one of the communicators 3A, 3B, and 3C, the client PC automatically adds the target flag FG to the contents DIN thereof every time the mouse-operating right is transferred from the main communicator 3A to any one of the sub-communicator 3B and 3C. This is because the transferred projector 2B or 2C or the like has more notified proportion in transferring the mouse-operating right from the main communicator 3A to any one of the sub-communicator 3B and 3C.

In the system 102, the target image flag FG concerning the target image is added to the contents DIN thereof using GUI function of the client PC (referred to as “Manual addition operation”). Based on this manual addition operation, when the presenter of materials and the assistant (s) therefor proceed with the presentation by the projector 2A, 2B or 2C and explain the corresponding image, they can add the target image flag FG to the contents DIN thereof. Such the previous addition of the target image flag FG allows the target image to which the target image flag FG is added to be automatically selected from plural contents DIN (still image) when generating and editing information on the presentation materials.

A creator 5 shown in FIG. 13 records the contents DIN displayed on the projectors 2A through 2C together with their time information and generates electronic information DOUT. The creator 5 in the third embodiment adds the following function to that the one in the second embodiment has. For example, the CPU 21 shown in FIG. 5 enables the contents DIN of the displayed subject to be read out of the storage device 23 and thus, the contents DIN concerning the target image are automatically or manually selected and edited on the basis of the target image flag FG that has been automatically or manually added concerning the contents DIN previously. The CPU 21 secures the edited contents DIN in data stream to generate the electronic information DOUT.

This allows the electronic information DOUT of the most notable target image to be collected from the contents DIN of the displayed subjects and to be secured in data stream. When reproducing the electronic information, it is possible to perform display processing, based on the target image flag FG, so that a contour of the target image can be highlighted as compared with another image. The creator 5 preferably delivers (broadcasts) the electronic information DOUT in the data-stream form to any communicator or client PC of another system in a remote site etc. in real time.

Next, the following will describe a method for automatically marking an image of plural images that the presenter of materials explains at present.

This embodiment has a function of marking the target image of plural images when recording the contents DIN of the presentation, and utilizes the target image flag FG when reproducing and editing the electronic information DOUT.

In this case, in a case \mathring{1} when the pages of image files displayed on the projectors 2A through 2C are changed, and in a case \mathring{2} when the mouse-operating right is transferred to the corresponding presentation materials, the target image flag FG is added to the contents DIN thereof to mark the target image. \mathring{3} Flag stay allowable time when the mouse-operating right can be transferred to the image and the target image flag FG can stay in the projector 2A or the like is defined as Tdisp.

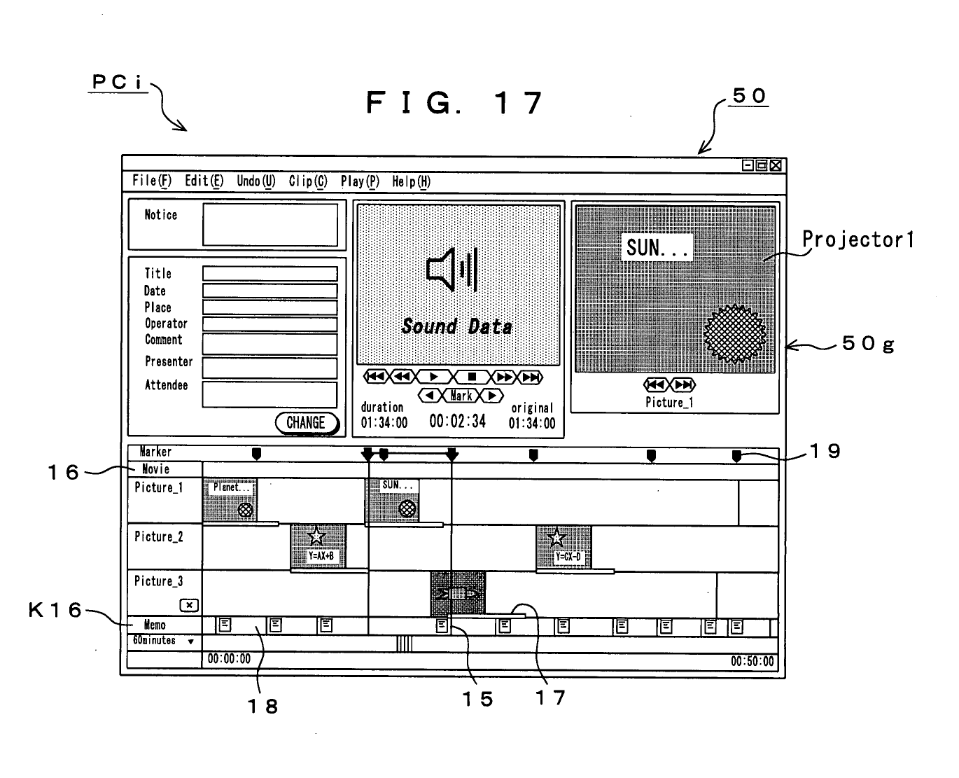

On an assumption of this, FIG. 15 shows operation examples in the three projectors 2A, 2B, and 2C. In the examples, cases where the image is renewed and where the mouse-operating right is transferred, are shown (as mouse control period: MOUSE CTL).

In each of the projectors 2A, 2B, and 2C shown in FIG. 15, one image is displayed during a period between shaded circles. The shaded circle symbols indicate image updated points and shaded bars indicate that the mouse-operating right and the target image flag FG are transferred to the corresponding projector. Items, (1) through (11) shown in FIG. 15 indicate displayed points of time, respectively, and have a relationship of (1)<(2)<(3) . . . <(11).

In this example, at each of the displayed points of time, (1) and (7), in the projector 2A shown in FIG. 15, a state where no target image flag FG is obtained and the screen is renewed is shown. Similarly, at each of the displayed points of time, (2) and (9), in the projector 2B, a state where no target image flag FG is obtained and the screen is renewed is shown. At each of the displayed points of time, (3) and (8), in the projector 2C, a state where no target image flag FG is obtained and the screen is renewed is shown.

At the displayed point of time, (4) in the projector 2A, the mouse-operating right is obtained and a target image flag FG is set in the projector 2A during only a predetermined period of time as the flag stay allowable time, Tdisp. In this example, Tdisp is set so that the displayed point of time, (4) when the mouse-operating right is obtained is a starting point of time.

If the target image flag FG is set just after the screen is renewed at the displayed point of time, (1) as the projector 2A, Tdisp is set with taking in consideration any time lag until obtaining the mouse-operating right. This causes a period of time the target image flag is occupied to be extended.

At the displayed point of time, (5) in the projector 2B, a mouse-operating right is obtained and a target image flag FG is set in the projector 2B during only a period of time, Tdisp [sec]. At the displayed point of time, (6) in the projector 2C, a mouse-operating right is obtained and a target image flag FG is set in the projector 2C during only a period of time, Tdisp [sec]. Note that, at the displayed point of time, (10) in the projector 2A, the target image flag FG is released after the flag stay allowable time, Tdisp has been passed.

When a screen is renewed during other projector 2B and the like occupy the target image flag FG at the displayed points of time, (2), (3), (8), and (9), the target image flag FG cannot be obtained immediately. In this case, at the displayed point of time, (7) as the projector 2A, the target image flag FG is obtained after the flag stay allowable time, Tdisp in the projector 2C or the like occupying the target image flag FG has been passed.

When the plural projectors 2A through 2C wait for obtaining the target image flag FG at the displayed point of time, (11) shown in FIG. 15, the projector 2C, which has renewed the screen before the projector 2B has renewed it, can obtain the target image flag FG. This is because the projector 2C has higher notable degree in the image to be next explained as compared with that in the projector 2B.

At the displayed point of time, (5), shown in FIG. 15, in the projector 2B, even if other projectors 2A, 2C or the like waits for obtaining the target image flag FG by means of renewing the image, the projector 2B may obtain the target image flag FG when the mouse-operating right is obtained. Similarly, at the displayed point of time, (6) in the projector 2C, even if other projectors 2A, 2B or the like waits for obtaining the target image flag FG by means of renewing the image, the projector 2C may obtain the target image flag FG when the mouse-operating right is obtained.

In this embodiment, when a term, A indicates whether or not each of the projectors 2A through 2C has the target image flag FG, a term, B indicates whether or not they have the mouse-operating right, and a term, C indicates a waiting order in renewing the image, an internal status, ms of each of the projectors 2A through 2C is defined as the following expression (1):
ms (PJi): [ABC] Expression (1)
where PJi is number of the projectors concerning the projectors 2A through 2C, which will be referred to “PJi (i=1 to 3)”.

Concerning the target image flag FG, if the corresponding projector obtains it, A=1; and if not, A=0. Concerning the mouse-operating right, if the corresponding projector obtains it, B=1; and if not, B=0. Concerning the waiting order in renewing the image, the waiting order on the mouse-operating right is indicated by figures. In this example, the figures, 1, 2, . . . are lined up in numerical order, so that when the corresponding projector 2A or the like obtains the target image flag FG, they are decreased in number by one.

The following will indicate relationships between the statuses ms (PJi) in each of the projectors 2A through 2C at the displayed points of time, (1) through (11), as shown in FIG. 15, according to the Expression (1). When each of the projectors 2A through 2C displays nothing, all of these statuses ms (PJ1) through ms (PJ3) are [000]. In the projector 2A, at the displayed point of time, (1), the status ms (PJ1) is [100]; at the displayed point of time, (4), the status ms (PJ1) is [110]; the displayed point of time, (5), the status ms (PJ1) is [000]; the displayed point of time, (7), the status ms (PJ1) is [100]; and the displayed point of time, (10), the status ms (PJ1) is [000].

Further, in the projector 2B, the displayed point of time, (2), the status ms (PJ2) is [101]; the displayed point of time, (5), the status ms (PJ2) is [110]; the displayed point of time, (6), the status ms (PJ2) is [000]; the displayed point of time, (9), the status ms (PJ2) is [002].

Additionally, in the projector 2C, the displayed point of time, (3), the status ms (PJ3) is [002]; the displayed point of time, (6), the status ms (PJ3) is [110]; the displayed point of time, (8), the status ms (PJ3) is [001]; the displayed point of time, (11), the status ms (PJ3) is [100]. Concerning the target image flag FG, FG=A so that it may be translated to FG=1 or FG=0.

Thus, CPU 32 on the communicator 3A or the like or CPU 25 of the creator 5 may recognize the internal status ms (PJi): [ABC] in each of the three projectors 2A through 2C and automatically determined. The displayed contents in which the automatically determined target image flag FG is linked with their time information may be stored in the storage device 23.

In this example, when the electronic information DOUT is reproduced in the projector 2 or the client PC, an image identified by a desired color is synthesized with the target image based on the target image flag FG.

According to the contents-reproduced screen 50f shown in FIG. 16, the image of the page 1 indicating a star projected by the projector 2A (Projector 1) is displayed on upper side of the middle portion of GUI screen 50; the image of the page 1 indicating a rocket projected by the projector 2C (Projector 3) is displayed on lower side of the middle portion thereof; and the image of page 1 indicating a star and an equation projected by the projector 2B (Projector 2) is displayed on upper side of the left portion thereof. These three images are concurrently displayed on a liquid crystal display 11 of the notebook personal computer PCi in color.

In the contents-reproduced screen 50f, an image to which the target image flag FG is added is displayed with a girdle of yellow display frame 13 as an example of the image identified by a desired color. Watching the image displayed with a girdle of yellow display frame 13 (illustrated by slashes in the drawing) allows attendees in the conference to immediately understand that the presenter of materials explains an image with him or her notifying it.

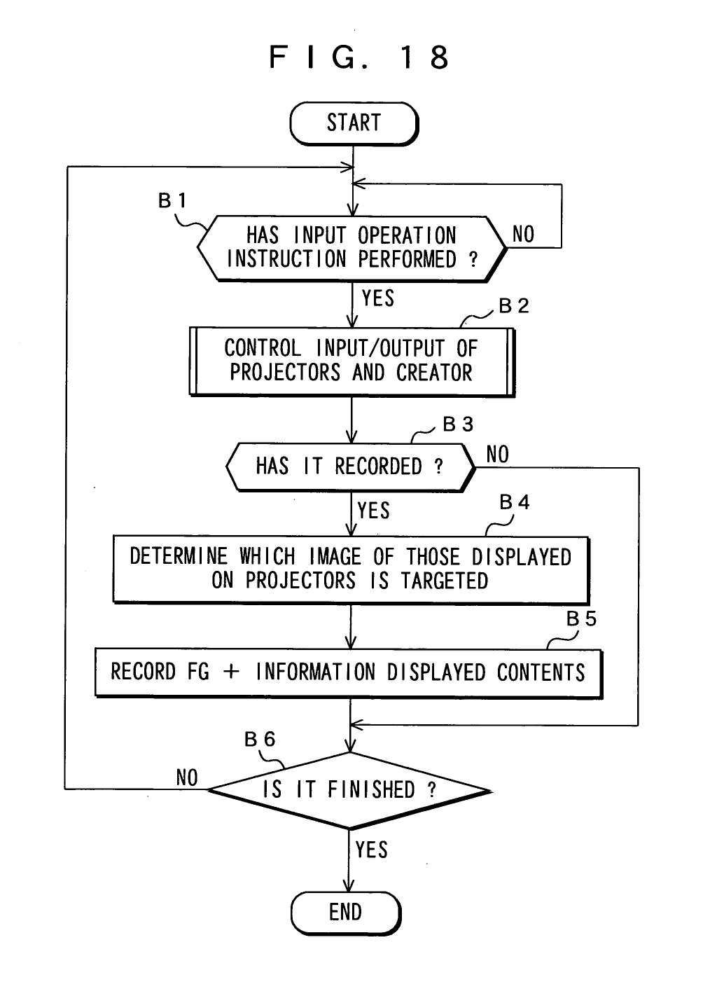

FIG. 17 shows a contents-editing screen 50g in the notebook personal computer PCi of the client. In this example, with a target image based on the target image flag FG, are synthesized a frame image of a desired color and/or a yellow line image. According to the contents-editing screen 50g shown in FIG. 17, the images (Pictures) by the three projectors 2A through 2C are displayed on lower half from a middle of GUI screen 50. In this example, at a line of Picture 1, an image of page 1 indicating a star and an image of page 2 indicating the sun, which are projected by the projector 2A, are displayed based on their time information.

At a line of Picture 2, an image of page 1 indicating a star and an equation of Y=AX+B and an image of page 2 indicating a star and an equation of Y=CX−D, which are projected by the projector 2B, are displayed based on their time information. At a line of Picture 3, an image of page 1 indicating a rocket, which is projected by the projector 2C, is displayed based on its time information.

In any Pictures 1 to 3, a time axis is indicated longitudinally as a time scale (Movie) 16 for motion image. Editing markers 19 composed of downward pentagonal symbols are provided at upper side of the time scale 16. In the Pictures 1 to 3, a yellow bar 17 as one example of the line image is displayed under the image indicated by the target image flag FG, as have been explained. The yellow bar 17 is indicates flag stay time, Tdisp, in the image to which the target image flag FG is added, so that correction processing such as deletion and movement can be performed therein by right-click operation etc. during the editing operation.

A memo key K16 is provided under the Picture 3, and a row of various kinds of icon keys 18 is arranged on the side of this key K16. A yellow display frame 15 that is movable longitudinally is arranged as one example of the image identified by a desired color with it stepping over display regions of the Pictures 1 to 3. In this example, the yellow display frame 15 steps over the image of page 2 indicating the sun projected by the projector 2A in the line of Picture 1 and the image of page 1 indicating the rocket projected by the projector 2C in the line of Picture 3 and covers them.

In this example, as compared with the image indicating the rocket in Picture 3, the mouse-operating right concerning the image indicating the sun in Picture 1 is previously obtained, so that the enlarged image indicating the sun in Picture 1 may be displayed on the right upper portion of the contents-editing screen 50g. Concerning the image indicating the rocket in Picture 3, when the display frame 15 is further moved in a right way so that the image indicating the sun in Picture 1 fades out of the display frame 15, a display on the right upper portion of the contents-editing screen 50g is changed from the image indicating the sun in Picture 1 to the image indicating the rocket in Picture 3 to display the enlarged image indicating the sun (Projector 1).

On the relationship between the yellow bar 17 and the display frame 15, if the display frame 15 includes the yellow bar 17, the enlarged image with the yellow bar 15 is displayed on the right upper portion of the contents-editing screen 50g. In other words, a equivalent relation between longitudinal movement of the display frame 15 and the target image tergeted by the presenter of materials can be controlled in the notebook personal computer PCi.

Next, the following will describe a processing example in the network electronic conference system 102.

In this embodiment, it is an assumption that the creator 5 (information-creating system I) and the three presentation apparatuses 10A through 10C (information controlling-and-displaying system II) are arranged in a conference room and the three notebook personal computers PCi (i=1 to 3: information processing system III) are prepared in the conference room. Further, the three projectors 2A through 2C display the still images.

The access point 6 is arranged as shown in FIG. 17 so that the three notebook personal computers PCi and the three communicators 2A through 2C are organized as wireless LAN configuration. The creator 5 and the three communicators 2A through 2C are connected with each other using HUBS 9C through 9E and the communication cable 40. Electronic equipment for network configuration such as the notebook personal computers PCi, the creator 5, the projectors 2A through 2C, and the communicators 3A through 3C, is powered on. The notebook personal computer PCi of the presenter of materials is then set as the client PC.

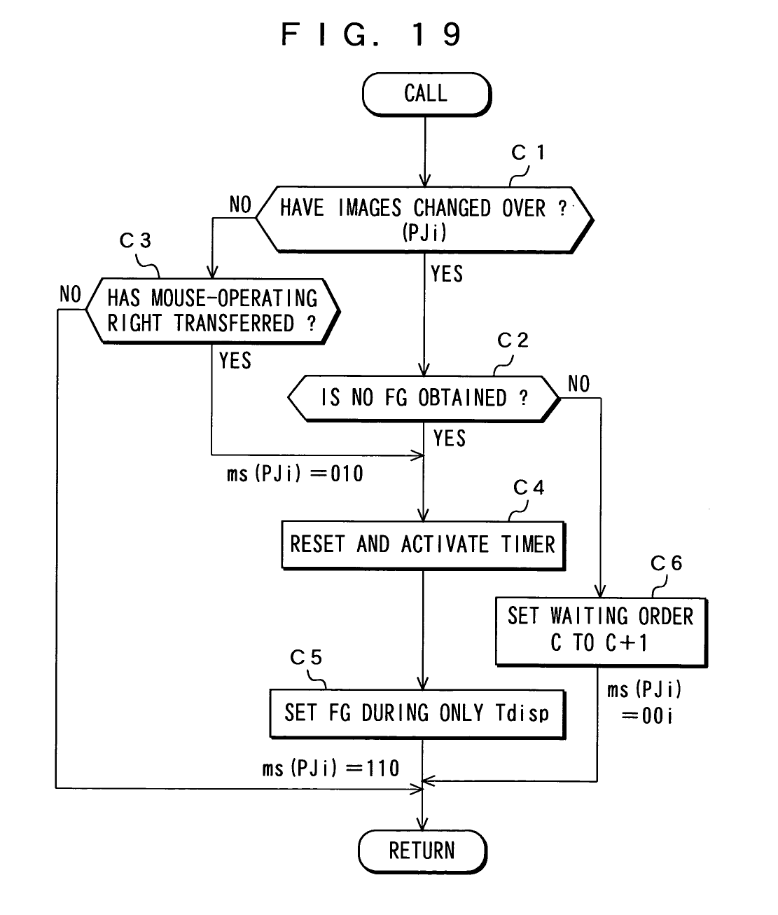

According to these processing requirements, at Step B1 in the flowchart as shown in FIG. 18, the main communicator 3 and the like wait for instruction for input operation from the client PC when a system program for a network electronic conference is activated in the client PC by the presenter of materials. When the client PC instructs the main communicator 3A to perform the input operation, the process goes to Step B2 where the main communicator 3A controls the information and the projector PJi performs display processing.

In the system 102, the three projectors 2A through 2C display the images for the presentation based on the information of materials transferred from the client PC. At this time, the main communicator 3A automatically adds the target image flag FG to the contents DIN every time the client PC switches the still image displays, for example.

When the client PC controls one of the three communicators 3A through 3C by remote control using the mouse 8, it automatically adds the target image flag FG to the contents DIN every time the mouse-operating right is transferred from the main communicator 3A to the sub-communicator 3B.

In this example, the target image flag FG is set when a switching event in the screen of the projector occurs or the projector PJi that has not yet obtained the mouse-operating right obtains it newly. When the target image flag FG is set, a subroutine shown in FIG. 19 is called and, at step C1 of the flowchart therefor, the main communicator 3A or the like checks whether the screen change occure in the corresponding projector number PJi. If the screen change occurs, the process goes to Step C2 where the main communicator 3A checks whether no projector PJi obtains the target image flag FG. If no target image flag FG is obtained, the process goes to Step C4.

If no screen change occurs in the corresponding projector number PJi, the process goes to Step C3 where it is checked whether the mouse-operating right is transferred from the corresponding communicator 3A or the like to the sub-communicator 3B. If the mouse-operating right is transferred, the process goes to Step C4 because the internal status in the projector number PJi becomes ms (PJi)=010.

At Step C4, a timer for setting the target image flag is reset and the timer is activated to set the flag stay time, Tdisp. The process then goes to Step C5 where the main communicator 3A or the like enables the target image flag FG to be set during only flag stay time, Tdisp. The internal status in this projector number PJi becomes ms (PJi)=110. The process then returns to Step B2 in the main flowchart shown in FIG. 18.

If any projectors PJi have been already obtained the target image flag FG at Step C2, the process goes to Step C6 where waiting order C of the corresponding projector PJi is set to C+1. When wait value (Wait) of the projector number PJi is set to [1] and another projector PJi has been already waited, the value of Wait is incremented by one (+1). The internal status of this projector number PJi becomes ms (PJi)=11i. The process then returns to Step B2 in the main flowchart shown in FIG. 18.

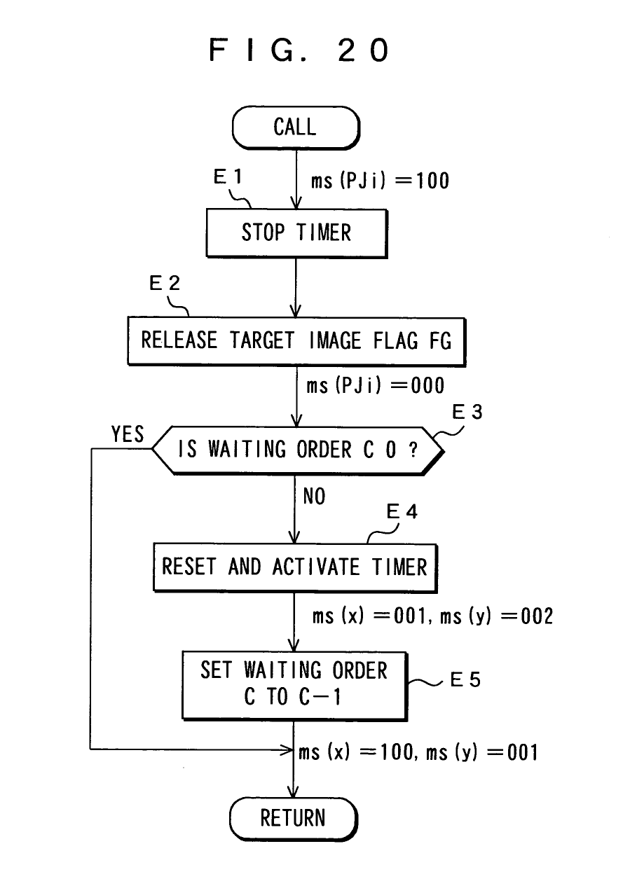

The timer for the target image flag FG indicates Tdisp and thus, the internal status of the projector number PJi becomes ms (PJi)=100. Thereafter, if the target image flag FG is released, a subroutine shown in FIG. 20 is called and, at Step E1 of this flowchart, the timer stops. At Step E2, the target image flag FG of the projector number PJi is released. This release causes the internal status in this projector number PJi to become ms (PJi)=000.

At Step E3, then the main communicator 3A or the like checks whether no projector PJi obtains the target image flag FG, namely, whether the waiting order C is [0]. In this check, the internal status ms (PJi) of the projector is detected. For example, the internal status of the projector number PJ2 is ms (PJ2)=001, and the internal status of the projector number PJ3 is ms (PJ3)=002. Note that if the waiting order C is [0], the process returns to Step B2 in the main flowchart shown in FIG. 18.

At Step E3, if the waiting order C is not [0], the process goes to Step E4 where the timer is reset and the timer is activated to set the flag stay time, Tdisp. The process then goes to Step E5 where the main communicator 3A or the like sets the waiting order (Wait value) C of the corresponding projector PJi to C-1. In other words, the wait value of the waiting projector is decreased by one.

As a result thereof, the target image flag FG is set during Tdisp to the projector number PJi having a value [0]. According to the above example, the internal status of the projector number PJ2 becomes ms (PJ2)=100, and the internal status of the projector number PJ3 becomes ms (PJ3)=001. The process then returns to Step B2 in the main flowchart shown in FIG. 18.

The process then goes to Step B3 where the main communicator 3A checks whether the contents DIN displayed respectively are stored in the creator 5. In this case, using input operation function of the client PC, a record instruction is sent to the main communicator 3A. the main communicator 3A checks whether the record has been made by detecting this record instruction.

If the contents DIN in the main communicator 3A are stored, the process goes to Step B4. If no contents DIN are stored, the process goes to Step B6. At Step B4, the main communicator 3A determines which presentation image of those of projectors 2A, 2B, and 2C is targeted at present. The target image is found out by detecting the target image flag FG added to the contents DIN in the main communicator 3A. The contents DIN to which the target image flag FG is added is the target image, and the contents DIN to which no target image flag FG is added is the non-target image.

The process then goes to Step B5 where the main communicator 3A controls the creator 5 so that the target image flag FG concerning the corresponding target image is linked with its time information and it records them. The creator 5 records the contents DIN displayed by the main communicator 3A together with their time information to generate the electronic information DOUT. The electronic information DOUT includes motion image.

At Step B6, based on a decision of stopping by the presenter of materials, remote controls of the projectors 2A through 2C, the communicators 3A through 3C, the creator 5, and the like by the client PC stop. In the projectors 2A through 2C, the communicators 3A through 3C, and the creator 5, power-off information is detected, thereby stopping the information processing. If those remote controls do not stop, the process goes back to Step B1 and the above Steps B1 through B5 are repeated.

Thus, according to the network electronic conference system 102 as the third embodiment of this invention, the client PC and the communicators 3A through 3C are connected with each other by wireless LAN via access point 6, and the communicators 3A through 3C and the creator 5 are connected with each other through HUBs 9A, and 9C through 9E and the communication cable 40. The main communicator 3A determines which image of those of projectors 2 the presenter of materials and the like target at present, and controls the creator 5 so that the target image flag FG is linked with its time information and it records them.

Thus, when reproducing the electronic information DOUT created by the creator 5, the target image can be displayed with its contour being highlighted as compared with another, based on the target image flag FG, so that its viewer can know which image of the reproduced images of the projectors 2 is the most notable at displayed time (see FIG. 16).

When editing the contents screen, in the notebook personal computer PCi, it can control display according to an equivalent relationship between that the display frame 15 can be moved longitudinally and that the presenter of materials targets the image (see FIG. 17). Thereby, such a network electronic conference system can be organized that the electronic information DOUT having the feeling of being at a live conference by collecting the target images of the presenter of materials, to which the target image mark is added, among plural presentation images, is able to be delivered through the network.

In this embodiment, a case where the three communicators 3A, 3B are used has been described, but the invention is not limited to such the case and thus, if such a configuration that one communicator is connected with plural projectors 2A through 2C and the like is taken, similar processing can be made by transferring the contents DIN of displayed subject and the target image flag FG to each of the control blocks in display device.

Concerning the above-mentioned network information processing system, the network electronic conference system 102 has been described, but the invention is not limited such the system, and thus, the invention is also applicable to the system in which plural network systems are connected with each other in remote sites and/or remote conference rooms.

### (4) Fourth Embodiment

In this fourth embodiment, it is an assumption that the network electronic conference system 102 concerning the third embodiment and newly arranged remote conference rooms A, B, and C are connected with each other by wired LAN, in which the presentation materials presented in the system 102 are reproduced and edited, and then, the electronic information DOUT is distributed to the remote conference rooms, A, B, and C at once.

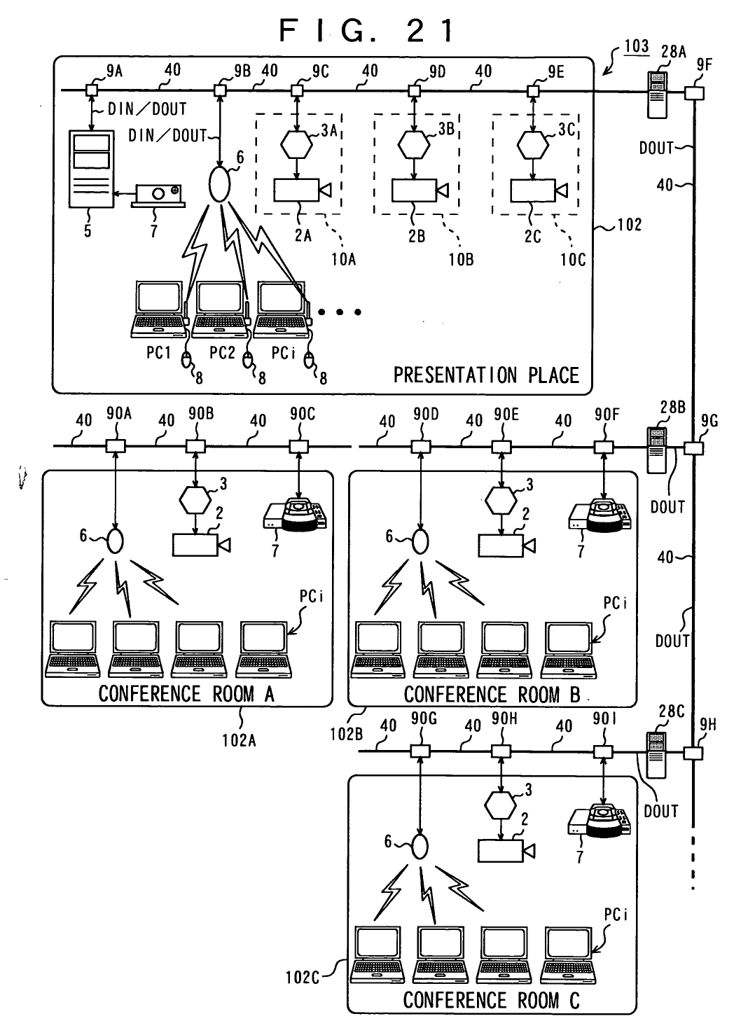

A network electronic conference system 103 of remote conference room type shown in FIG. 21 is organized so that an electronic conference system 103A of the conference room A as the remote conference room organized in a presentation place, an electronic conference system 103A of the conference room A as the remote conference room, an electronic conference system 103B of the conference room B, and an electronic conference system 103C of the conference room C are connected with each other through the communication cable 40 and gateway devices (servers) 28A, 28B, and 28C.

Because the internal configuration of the electronic conference system 102 has been described with reference to FIG. 17, the explanation thereof is omitted. HUB 9E is connected with the gateway device 28A through the communication cable 40. The gateway apparatus 28A is further connected to HUB 9F through the communication cable 40, and this HUB 9F is connected to HUBs 9G and 9H through the communication cable 40.

HUB 9G is connected with the gateway device 28B and HUB 9H is connected with the gateway device 28C. The gateway apparatus 28B is connected to HUBs 90A through 90F through the communication cable 40. The gateway apparatus 28C is connected to HUBs 90G through 90I through the communication cable 40.

In each of the electronic conference systems, 103A, 103B, and 103C, as electronic equipment for network configuration, one projector 2, communicator 3, access point 6, and television conference apparatus 7 are arranged and as information processing apparatus, four notebook personal computer PCi are prepared.

In the system 103A, HUB 90A is connected to the access point 6, HUB 90B is connected to the comunicator 3, and HUB 90C is connected to the television conference apparatus 7. In the system 103B, HUB 90D is connected to the access point 6, HUB 90E is connected to the communicator 3, and HUB 90F is connected to the television conference apparatus 7.

In the system 103C, HUB 90G is connected to the access point 6, HUB 90H is connected to the communicator 3, and HUB 90I is connected to the television conference apparatus 7. Each of the communicator 3 is connected to the projector 2.

According to the embodiment, a target image concerning a proceeding conference with plural presentation images in the network electronic conference system 102, which is the presentation place, is selected and the electronic information DOUT secured in one stream by the creator 5 is broadcast to the conference rooms A to C. Thereby, the electronic information DOUT having the feeling of being at a live conference by collecting the target images of the presenter of materials, to which the target image mark is added, among plural presentation images, is able to be viewed in the conference rooms A to C.

Concerning the above-mentioned network information processing system, the electronic conference system has been described, but the invention is not limited such the system, and thus, the invention is also applicable to a network education system, a network game system, and the like.

For example, when the network education system is organized, every student is provided with a notebook personal computer PCi and then, each notebook personal computer PCi and study-assistant display device (information control display device) including a communicator and a projector are connected with each other by communication means such as wireless LAN. The study-assistant display device and the creator 5 are connected with each other through the communication cable 40. According to this system, it is determined which image of those of the study-assistant display devices is targeted at present based on an input operation function of a notebook personal computer PCi operated by a student. In this system, an image selection mark concerning the target image is linked with its time information and the creator 5 records them. The system allows important study portion (contents) that is most notable in the study contents to be secured in data stream. In addition to this, the system allows the target image to be highlighted and displayed, for example, as compared with another image when reproducing the contents.

Further, when the network game system is organized, every game entry is provided with a notebook personal computer PCi and then, each notebook personal computer PCi and game-assistant display device (information control display device) including a communicator and a projector are connected with each other by communication means such as wireless LAN. The game-assistant display device and the creator 5 are connected with each other through the communication cable 40. According to this system, it is determined which image of those of the game-assistant display devices is targeted at present based on an input operation function of a notebook personal computer PCi operated by a game entry. In this system, an image selection mark concerning the target image is linked with its time information and the creator 5 records them. The system allows important game portion (contents) that is the most notable in the game contents to be secured in data stream. In addition to this, the system allows the target image to be highlighted and displayed, for example, as compared with another image when reproducing the contents.

### PROBABILITY OF UTILIZED INDUSTRIALIZATION

The present invention is well applicable to a network electronic conference system, a network education system, a network game system, etc.

1. A network-information-processing system comprising:
at least one information-processing apparatus having an input operation function to process arbitrary information;
at least one information-controlling-and-displaying means for displaying an image based on information transferred from said information-processing apparatus;
information-creating apparatus for storing contents displayed on the information-controlling-and-displaying means together with their time information to create electronic information;
communication means for connecting at least the information-processing apparatus, the information-controlling-and-displaying means and the information-creating apparatus;
determining means for determining which image of those displayed on the information-controlling-and-displaying means at present is targeted; and
identification-information-adding means for adding identification information indicating the target image that is determined by the determining means to the time information.

2. The network-information-processing system according to claim 1, wherein
said information-controlling-and-displaying means including a display apparatus for displaying an image based on information transferred from said information-processing apparatus; and
information-processing-assisting apparatus for assisting information processing in a network including said display apparatus based on the input operation function by said information-processing apparatus.

3. The network-information-processing system according to claim 1 further comprising a motion-picture-and-audio-inputting apparatus for inputting at least one of image and audio other than the information transferred from said information-processing apparatus.

4. The network-information-processing system according to claim 1, wherein in a case where said information-controlling-and-displaying means and/or said information-processing apparatus display a still image, said information-controlling-and-displaying means adds said identification information to the contents every time said information-processing apparatus changes still image display.

5. The network-information-processing system according to claim 1, wherein when one of said information-processing apparatuses sets as an information-controlling right a right to control information in one of said information-controlling-and-displaying means, said information-processing apparatus adds said identification information to the contents every time said information-controlling right is transferred from said information-controlling-and-displaying means to another information-controlling-and-displaying means.

6. The network-information-processing system according to claim 1, wherein identification information relative to said target image is added to the contents using the input function of said information-processing apparatus.

7. The-network-information-processing system according to claim 1, wherein said information-creating apparatus selects the electronic information concerning the target image based on the identification information automatically or manually added relative to the contents displayed on said information-controlling-and-displaying means to distribute the selected one to said information-controlling-and-displaying means and/or said information-processing apparatus.

8. The-network-information-processing system according to claim 1, wherein said information-creating apparatus selects the target image automatically or manually among said contents based on said identification information and edits it, and secures the contents thus edited in data stream to create said electronic information.

9. The-network-information-processing system according to claim 1, wherein in a case where said electronic information is reproduced in said information-controlling-and-displaying means and/or said information-processing apparatus, identified image having a desired color is synthesized to the target image based on said identification information.

10. The-network-information-processing system according to claim 9, wherein frame image and/or line image each having a desired color are/is synthesized to the target image based on said identification information.

11. An information-creating apparatus for storing desired contents together with their time information to create electronic information, said apparatus comprising:
storage device for storing said contents together with their time information; and
controlling apparatus for selecting contents concerning the target image based on identification information automatically or manually added beforehand relative to the contents stored in said storage device to send the selected contents.

12. The information-creating apparatus according to claim 11, wherein said controlling apparatus automatically selects the target image among said contents based on said identification information to edit it, and secures the contents thus edited in data stream to create said electronic information.

13. An information-processing method comprising the steps of:
connecting at least one information-processing system having an input operation function to process arbitrary information, at least one information-controlling-and-displaying system for displaying an image based on information transferred from said information-processing system, and the information-creating system for storing contents displayed on the information-controlling-and-displaying system together with their time information to create electronic information to each other through the communication means;
in storing the contents in the information-creating system, determining which image of those displayed on the information-controlling-and-displaying system at present is targeted; and
adding identification information indicating the target image thus determined to the time information.

14. The information-processing method according to claim 13, wherein a system for allowing a presenter to proceed with his/her presentation with multiple presentation materials being concurrently displayed on said information-controlling-and-displaying system including a projector is organized;
wherein in storing contents of the presentation in said system thus organized, a status for controlling network equipment including the information-processing system, the information-controlling-and-displaying system, and the information-creating system that are connected through said communication means is acknowledged;
wherein it is determined which screen is explained at present based on the status thus acknowledged;
wherein an image selection mark is marked on the contents of presentation thus determined as image to be targeted at this time;
wherein the image selection mark thus marked is linked with the time information.

15. The information-processing method according to claim 14, wherein in a process of said presentation, an image selection mark indicating which screen is explained at present is marked according to manual operation of said information-processing system by another attendee.

16. The information-processing method according to claim 14, wherein in reproducing the contents of said presentation, it is acknowledged based on said image selection mark that the presentation is performed using a screen of reproduced multiple screens.

17. The information-processing method according to claim 14, wherein contents-editing system for allowing the contents of said presentation to be edited and prepared to one stream form that is capable of being broadcast to create electronic information is organized; and
wherein in said contents-editing system thus organized, a screen is automatically or manually selected among the screens proceeded on the basis of the image selection mark.

18. The information-processing method according to claim 13, wherein a system for allowing contents in a conference to be secured in data stream relative to contents displayed on said information-controlling-and-displaying system to preferably send them out in real time is organized;
wherein an image marked with the image selection mark is automatically selected of multiple presentation screens by said system thus organized and sent out.

19. The information-processing method according to claim 13, wherein in a case where said information-controlling-and-displaying system and/or said information-processing system display(s) a still image, said identification information is added to the contents displayed on said information-controlling-and-displaying system every time said information-processing system changes still image display.

20. The information-processing method according to claim 13, wherein when one of said information-processing systems sets as am information-controlling right a right to control information in one of said information-controlling-and-displaying systems, said identification information is added to the contents displayed on said information-controlling-and-displaying system every time said information controlling right is transferred from said information-controlling-and-displaying system to another information-controlling-and-displaying system.
